(19) United States
(12) Patent Application Publication
(10) Pub. No.: US 2024/0103198 A1
(43) Pub. Date: Mar. 28, 2024

(54) WINDOW, METHOD OF MANUFACTURING THE WINDOW, AND DISPLAY DEVICE HAVING THE WINDOW

(71) Applicant: SAMSUNG DISPLAY CO., LTD., YONGIN-SI (KR)

(72) Inventor: SU-HYOUNG KANG, Yongin-si (KR)

(21) Appl. No.: 18/459,742

(22) Filed: Sep. 1, 2023

(30) Foreign Application Priority Data
Sep. 8, 2022 (KR) 10-2022-0114035

(51) Int. Cl. G02B 1/04

(52) U.S. Cl. CPC G02B 1/04; G06F 1/1652

(57) ABSTRACT

A window includes a base layer, a high refractive layer which is disposed on the base layer and includes a first polymer derived from a first resin composition containing a highly stretchable material, and a low refractive layer which is disposed on the high refractive layer and includes a second polymer derived from a second resin composition containing hollow particles and a first initiator including and fluorine. The highly stretchable material is represented by Formula A-1 or Formula A-2 below, and the second resin composition contains about 5 wt % or less of the first initiator with respect to the total amount of the second resin composition.

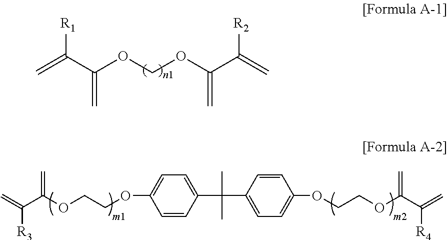

### CROSS-REFERENCE TO RELATED APPLICATION

This U.S. non-provisional patent application claims priority under 35 U.S.C. § 119 of Korean Patent Application No. 10-2022-0114035, filed on Sep. 8, 2022, the entire contents of which are hereby incorporated by reference.

### BACKGROUND

The present disclosure herein relates to a window, a method of manufacturing the window, and a display device having the window.

Various electronic devices used in multimedia devices such as a television, a mobile phone, a tablet computer, a navigation device, and a game console are being developed. Recently, electronic devices which are foldable or rollable using flexible display members that are bendable are being under development to enable ease of portability and increase user's convenience.

In order to achieve flexible characteristics, the window for protecting a display surface of the electronic device also uses a polymer film as a substrate, but there is a limitation in that use of the polymer film causes the deterioration of optical properties and impact resistance of the window.

### SUMMARY

The present disclosure provides a window having an improvement in both optical properties and impact resistance.

The present disclosure also provides a display device that includes the window having an improvement in both optical properties and impact resistance, thereby improving display quality and durability.

An embodiment of the present disclosure provides a window including a base layer, a high refractive layer which is disposed on the base layer and includes a first polymer derived from a first resin composition containing a highly stretchable material, and a low refractive layer which is disposed on the high refractive layer and includes a second polymer derived from a second resin composition containing hollow particles and a first initiator including fluorine, wherein the highly stretchable material is represented by Formula A-1 or Formula A-2 below, and the second resin composition contains about 5 wt % or less of the first initiator with respect to the total amount of the second resin composition.

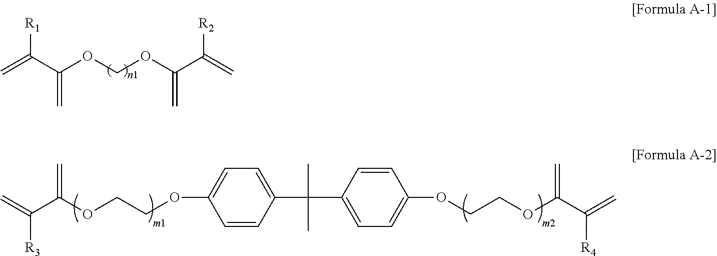

In Formulae A-1 and A-2 above, R₁ to R₄ are each independently a hydrogen atom or a substituted or unsubstituted methyl group, n1 is an integer selected from a range of 6 to 10, each of m1 and m2 is an integer independently selected from a range of 1 to 20, and the sum of m1 and m2 is 30 or less.

In an embodiment, the highly stretchable material may be represented by Formula A-1 above, and the first resin composition may contain about 5 wt % or less of the highly stretchable material with respect to the total amount of the first resin composition.

In an embodiment, the highly stretchable material may be represented by Formula A-2 above, and the first resin composition may contain about 5 wt % to about 10 wt % of the highly stretchable material with respect to the total amount of the first resin composition.

In an embodiment, the high refractive layer may have a thickness selected from a range of about 3,000 nm to about 5,000 nm, and the low refractive layer may have a thickness selected from a range of about 50 nm to 90 nm.

In an embodiment, the high refractive layer may have a refractive index selected from a range of about 1.52 to about 1.67, and the low refractive layer may have a refractive index selected from a range of about 1.42 to about 1.50.

In an embodiment, the high refractive layer may further include at least one of a tin oxide (SnOₓ), a titanium oxide (TiOₓ), a zirconium oxide (ZrOₓ), and a sulfur atom.

In an embodiment, the low refractive layer may include a first low refractive layer which is disposed on the high refractive layer and includes the hollow particles, and a second low refractive layer including the fluorine.

In an embodiment, the second resin composition may further include a second initiator different from the first initiator.

In an embodiment, the hollow particles may have an average diameter selected from a range of about 50 nm to about 90 nm.

In an embodiment, an amount of the hollow particles contained in the second resin composition may be selected from a range of about 25 wt % to about 35 wt % with respect to the total amount of the second resin composition.

In an embodiment, the window may further include a functional layer which is disposed on the low refractive layer and includes a fluorine-containing compound.

In an embodiment, the window may further include an adhesive layer which is disposed between the functional layer and the low refractive layer and includes a silane coupling agent, wherein the silane coupling agent may have an atomic ratio of nitrogen atoms and silicon atoms that is selected from a range of about 1:1.8 to about 1:2.2.

In an embodiment of the present disclosure, a display device includes a display panel, and a window disposed on the display panel, wherein the window includes a base layer, a high refractive layer which is disposed on the base layer and includes a first polymer derived from a first resin composition containing a highly stretchable material, and a low refractive layer which is disposed on the high refractive layer and includes a second polymer derived from a second resin composition containing hollow particles and a first initiator including fluorine, wherein the highly stretchable material is represented by Formula A-1 or Formula A-2 below, and the second resin composition includes about 5 wt % or less of the first initiator with respect to the total amount of the second resin composition.

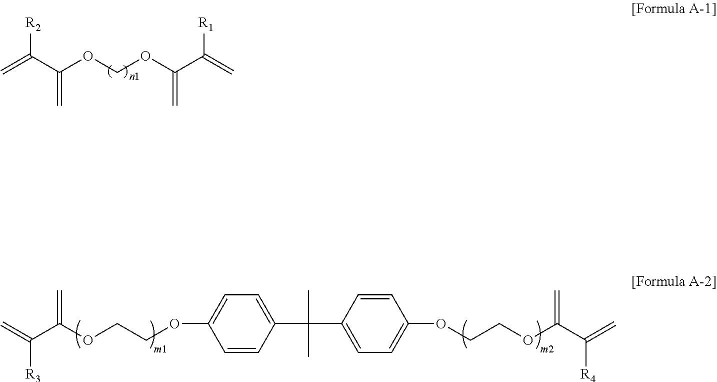

In Formulae A-1 and A-2 above, R₁ to R₄ are each independently a hydrogen atom or a substituted or unsubstituted methyl group, n1 is an integer selected from a range of 6 to 10, each of m1 and m2 is an integer selected from a range of 1 to 20, and the sum of m1 and m2 is 30 or less.

In an embodiment, the highly stretchable material may be represented by Formula A-1 above, and the first resin composition may contain about 5 wt % or less of the highly stretchable material with respect to the total amount of the first resin composition.

In an embodiment, the highly stretchable material may be represented by Formula A-2 above, and the first resin composition may contain about 5 wt % to about 10 wt % of the highly stretchable material with respect to the total amount of the first resin composition.

In an embodiment, the high refractive layer may have a thickness selected from a range of about 3,000 nm to about 5,000 nm, and the low refractive layer may have a thickness selected from a range of about 50 nm to 90 nm.

In an embodiment, the low refractive layer may include a first low refractive layer which is disposed on the high refractive layer and includes the hollow particles, and a second low refractive layer including the fluorine.

In an embodiment, an amount of the hollow particles contained in the second resin composition is selected from a range of about 25 wt % to about 35 wt % with respect to the total amount of the second resin composition.

In an embodiment, the display device may include at least one folding region which is folded with respect to a folding axis extending in one direction.

In an embodiment of the present disclosure, a method for manufacturing a window, the method including: preparing a base layer; applying, on one surface of the base layer, a first resin composition containing a highly stretchable material to form a high refractive layer; and applying, on the high refractive layer, a second resin composition containing hollow particles and a first initiator including fluorine to form a low refractive layer, wherein the highly stretchable material is represented by Formula A-1 or Formula A-2 below, and the second resin composition contains about 5 wt % or less of the first initiator with respect to the total amount of the second resin composition.

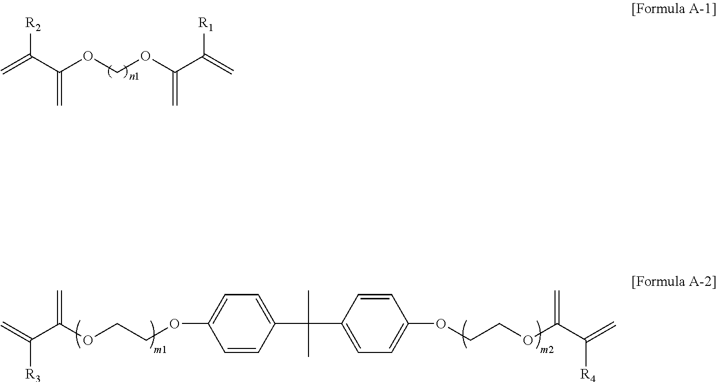

In Formulae A-1 and A-2 above, R₁ to R₄ are each independently a hydrogen atom or a substituted or unsubstituted methyl group, n1 is an integer selected from a range of 6 to 10, each of m1 and m2 is an integer independently selected from a range of 1 to 20, and the sum of m1 and m2 is 30 or less.

### BRIEF DESCRIPTION OF THE FIGURES

The accompanying drawings are included to provide a further understanding of the present disclosure, and are incorporated in and constitute a part of this specification. The drawings illustrate exemplary embodiments of the present disclosure and, together with the description, serve to explain principles of the present disclosure. In the drawings:

FIG. 1A is a perspective view illustrating an unfolded state of a display device according to an embodiment of the present disclosure;

FIG. 1B is a perspective view illustrating an inner-folding process of the display device according to an embodiment of present disclosure;

FIG. 1C is a perspective view illustrating an outer-folding process of the display device according to an embodiment of present disclosure;

FIG. 2A is a perspective view illustrating an unfolded state of a display device according to an embodiment of present disclosure;

FIG. 2B is a perspective view illustrating an inner-folding process of the display device according to an embodiment of present disclosure;

FIG. 3 is an exploded perspective view of the display device according to an embodiment of the present disclosure;

FIG. 4 is a cross-sectional view of the display device according to an embodiment of the present disclosure;

FIG. 5A is a cross-sectional view of a window according to an embodiment of the present disclosure;

FIG. 5B is a cross-sectional view of a low refractive layer according to an embodiment of the present disclosure;

FIGS. 6A and 6B are cross-sectional views of the window according to an embodiment of the present disclosure;

FIG. 7 is a flowchart illustrating a method of manufacturing a window according to an embodiment of the present disclosure;

FIGS. 8A to 8D are views schematically illustrating steps for manufacturing the window according to an embodiment of the present disclosure;

FIG. 8E is an enlarged view of a cross-sectional view illustrating a part of the steps for manufacturing the window according to an embodiment of the present disclosure; and

FIG. 9 is a view showing a reflection spectrum of the windows of Example and Comparative Example.

### DETAILED DESCRIPTION

Hereinafter, embodiments of the present disclosure will be described with reference to the accompanying drawings.

In this specification, it will also be understood that when a component (a region, a layer, a portion, or the like) is referred to as “being on,” “being connected to,” or “being coupled to” another component, it may be directly connected/coupled to another component, or an intervening third component may be also disposed therebetween.

Like reference numerals refer to like components throughout. Also, in the drawings, the thicknesses, ratios, and dimensions of the components are exaggerated for effective description of technical contents. The term “and/or” includes all combinations of one or more of which associated configurations may define.

It will be understood that, although the terms “first”, “second”, etc. may be used herein to describe various components, these components should not be limited by these terms. These terms are only used to distinguish one component from another. For example, a first component could be termed a second component, and, similarly, a second component could be termed a first component, without departing from the scope of the present disclosure. As used herein, the singular forms, “a,” “an,” and “the” are intended to include the plural forms as well, unless the context clearly indicates otherwise.

In addition, terms such as “below,” “on the lower portion of,” “above,” “on the upper portion of,” and the like are used to describe the relationship of the configurations shown in the drawings. The terms are used as a relative concept and are described with reference to the direction indicated in the drawings.

It should be understood that the terms “comprise,” or “have” are intended to specify the presence of stated features, integers, steps, operations, components, parts, or combinations thereof in the disclosure, but do not preclude the presence or addition of one or more other features, integers, steps, operations, components, parts, or combinations thereof.

Being “directly disposed on” herein means that there are no intervening layers, films, regions, plates, or the like between a part such as a layer, a film, an area, and a plate and another part. For example, being “directly disposed on” may mean being disposed between two layers or two members without using an additional member, such as an adhesive member.

Unless otherwise defined, all terms (including technical and scientific terms) used herein have the same meaning as commonly understood by one of ordinary skill in the art to which the present disclosure belongs. In addition, it will be understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a window and a display device including the same according to an embodiment of the present disclosure will be described with reference to the drawings.

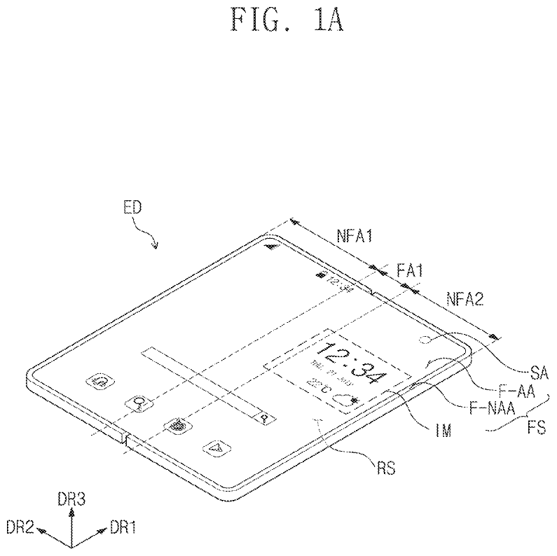

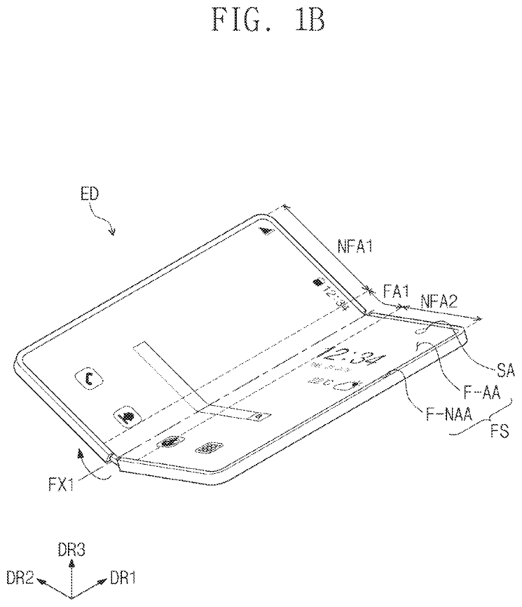

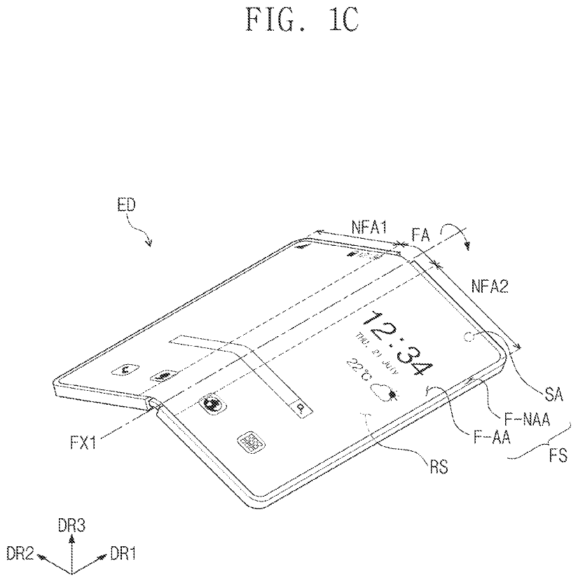

FIG. 1A is a perspective view illustrating an unfolded state of a display device according to an embodiment of the present disclosure. FIG. 1B is a perspective view illustrating an inner-folding process of the display device illustrated in FIG. 1A. FIG. 1C is a perspective view illustrating an outer-folding process of the display device illustrated in FIG. 1A.

The display device ED of an embodiment may be a device that is activated according to an electrical signal. For example, the display device ED may be a mobile phone, a tablet, a car navigation device, a game console, or a wearable device, but the embodiment of the present disclosure is not limited thereto. FIG. 1A in the present specification exemplarily illustrate that the display device ED is a mobile phone.

FIGS. 1A to 1C illustrate the display device ED as a foldable display device which is transformed to a folded form, but the embodiment of the present disclosure is not limited thereto, and the display device ED of an embodiment may be a flexible display device which may be transformed by being bent or rolled.

Meanwhile, FIG. 1A and the drawings below illustrate the first direction DR1 to third direction DR3, and the directions indicated by the first to third directions DR1, DR2 and DR3 described in this specification are relative concepts and may be converted into other directions. In addition, the directions indicated by the first to third directions DR1, DR2 and DR3 may be described as first to third directions, and the same reference symbols may be used.

Referring to FIGS. 1A to 1C, the display device ED according to an embodiment may include a display surface FS defined by a first direction DR1 and a second direction DR2 crossing the direction axis DR1. The display device ED may provide an image IM for a user through the display surface FS. The display device ED of an embodiment may display the image IM toward the third direction DR3 on the display surface FS parallel to each of the first direction DR1 and the second direction DR2. In the present specification, a front surface (or a top surface) or a rear surface (or a bottom surface) of each of the constituents may be defined with respect to a direction in which the image IM is displayed.

The display device ED according to an embodiment may detect external inputs applied from the outside. The external inputs may include various forms of inputs provided from the outside of the display device ED. For example, the external inputs may be recognized or detected when approaching the display device ED or being adjacent by a preset distance (e.g., hovering), as well as by contact of a part of a body such as a user's hand. In addition, the external inputs may have various forms such as force, pressure, temperature, and light.

The display surface FS of the display device ED may include an active region F-AA and a peripheral region F-NAA. The active region F-AA may be a region which is activated in response to an electrical signal. The display device ED according to an embodiment may display the image IM through the active region F-AA. In addition, the electronic device ED may detect various forms of external inputs in the active region F-AA. The peripheral region F-NAA is adjacent to the active region F-AA. The peripheral region F-NAA may have a certain color. The peripheral region F-NAA may surround the active region F-AA. Accordingly, the shape of the active region F-AA may be defined by the peripheral region F-NAA. However, this is illustrated by way of example, and the peripheral region F-NAA may be disposed adjacent to only one side of the active region F-AA, or may be omitted. The display device ED according to an embodiment of the present disclosure may include active regions having various shapes and is not limited to any one embodiment.

The active region F-AA may include a sensing region SA. The sensing region SA may have various electronic modules disposed. For example, the electronic module may include at least one of a camera module, a speaker, a light detection sensor, and a thermal detection sensor. The sensing region SA may detect an external subject received through the display surface FS or may provide sound signals such as voice to the outside through the display surface FS. The electronic module may include a plurality of components, and is not limited to any one embodiment.

The sensing region SA may be surrounded by the active region F-AA and the peripheral region F-NAA. However, the embodiment of the present disclosure is not limited thereto, and the sensing region SA may be disposed in the active region F-AA, but is not limited to any one embodiment. FIG. 1A exemplarily illustrates a single sensing region SA, but the number of the sensing regions SA-DD is not limited thereto.

The sensing region SA may be a portion of the active region F-AA. Accordingly, the display device DD may also display a video through the sensing region SA. When the electronic modules disposed in the sensing region SA are inactivated, the sensing region SA as a display surface may display a video or an image.

A rear surface RS of the display device ED of an embodiment may face the display surface FS. The rear surface RS of an embodiment is an external surface of the display device ED, and may not display a video or an image. However, the embodiment of the present disclosure is not limited thereto, and the rear surface RS may function as a second display surface which displays a video or an image. In addition, the display device ED of an embodiment may further include a sensing region disposed on the rear surface RS. In the sensing region of the rear surface RS, a camera, a speaker, or a light detection sensor may be disposed.

The display device ED may include a folding region FA1 and non-folding regions NFA1 and NFA2. The display device ED may include a plurality of non-folding regions NFA1 and NFA2. The display device ED of an embodiment may include a first non-folding region NFA1 and a second non-folding region NFA2 disposed with the folding region FA1 located therebetween. Meanwhile, FIGS. 1A to 1C illustrate an embodiment of the display device ED including one folding region FA1, but the embodiment of the present disclosure is not limited thereto, and a plurality of folding regions may be defined in the display device ED. However, the embodiment of the present disclosure is not limited thereto, and the display device ED of an embodiment may be folded with respect to a plurality of folding axes so that parts of the display surface FS face each other, and the number of folding axes and the number of non-folding regions corresponding thereto are not particularly limited.

Referring to FIGS. 1B and 1C, the display device ED according to an embodiment may be folded with respect to a first folding axis FX1. The first folding axis FX1 illustrated in FIGS. 1B and 1C is an imaginary axis extending in the first direction DR1, and the first folding axis FX1 may be parallel to the direction of the long sides of the display device ED. However, the embodiment of the present disclosure is not limited thereto, and the extending direction of the folding axis FX1 is not limited to the first direction DR1.

The first folding axis FX1 may extend in the first direction DR1 on the display surface FS, or may extend in the first direction DR1 below the rear surface RS. Referring to FIG. 1B, in an embodiment, the first non-folding region NFA1 and the second non-folding region NFA2 may face each other, and the display device ED may be inner-folded so that the display surface FS is not exposed to the outside. In addition, referring to FIG. 1C, the display device ED according to an embodiment may be folded with respect to the first folding axis FX1 to be transformed into an outer-folded state in which one region overlapping the first non-folding region NFA1 and the other region overlapping the second non-folding region NFA2 on the rear surface RS face each other.

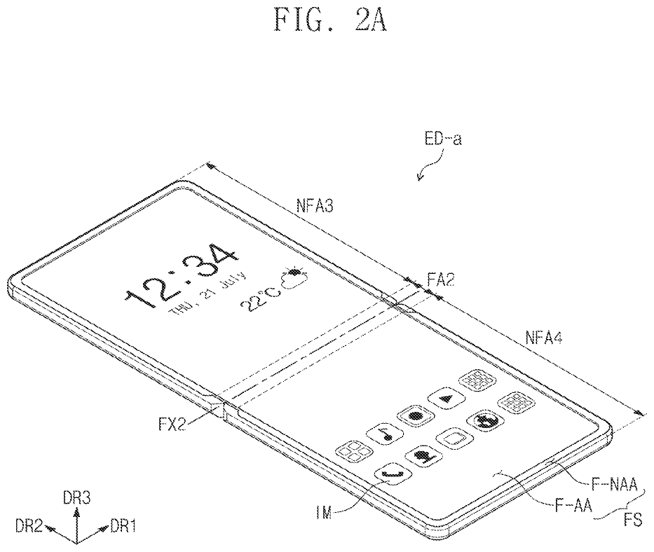

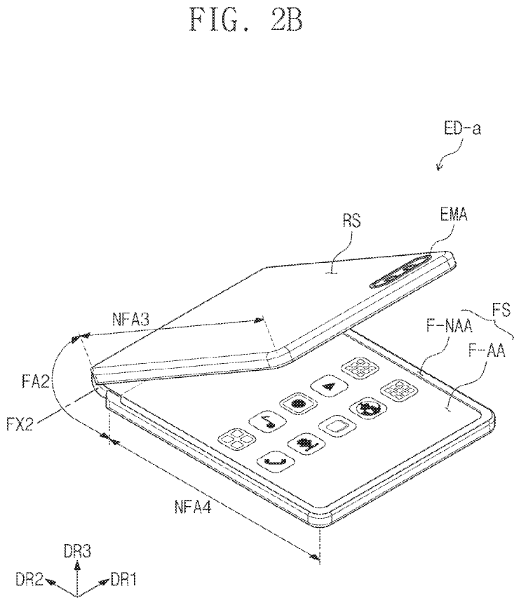

FIG. 2A is a perspective view illustrating an unfolded state of a display device according to an embodiment of the present disclosure. FIG. 2B is a perspective view illustrating an inner-folding process of the display device illustrated in FIG. 2A.

The display device ED-a according to an embodiment may be folded with respect to a second folding axis FX2 extending in one direction parallel to the first direction DR1. FIG. 2B illustrates the case where the extending direction of the second folding axis FX2 is parallel to the extending direction of the short sides of the display device ED-a. However, the embodiment of the present disclosure is not limited thereto.

The display device ED-a according to an embodiment may include at least one folding region FA2 and non-folding regions NFA3 and NFA4 adjacent to the folding region FA2. The non-folding regions NFA3 and NFA4 may be disposed to be spaced apart from each other with the folding region FA2 located therebetween.

The folding region FA2 has a preset curvature and radius of curvature. In an embodiment, a first non-folding region NFA3 and a second non-folding region NFA4 may face each other, and the display device ED-a may be inner-folded so that the display surface FS is not exposed to the outside.

In addition, unlike the configuration illustrated, in an embodiment, the display device ED-a may be outer-folded so that the display surface FS is exposed to the outside. Meanwhile, for the display device ED-a in an embodiment, the first display surface FS in a non-folded state may be viewed by a user, and a second display surface RS in an inner-folded state may be viewed by a user. The second display surface RS may include an electronic module region EMA in which an electronic module including various components is disposed.

The display device ED-a according to an embodiment may include the second display surface RS, and the second display surface RS may be defined as a surface opposite to at least a portion of the first display surface FS. In the inner-folded state, the second display surface RS may be viewed by a user. The second display surface RS may include an electronic module region EMA in which an electronic module including various components is disposed. Meanwhile, in an embodiment, an image may be provided through the second display surface RS.

In an embodiment, the display devices ED and ED-a may be configured so that the inner-folding or outer-folding operation from an unfolding operation is repeated, but the embodiment of the present disclosure is not limited thereto. In an embodiment, the display devices ED and ED-a may be configured so that any one among the unfolding operation, inner-folding operation, and outer-folding operation may be selected.

FIGS. 1A to 2B illustrate the display devices ED and ED-a as foldable display devices which are transformed to a folded form, but the embodiment of the present disclosure is not limited thereto, and the display devices ED and ED-a of embodiments may be flexible display devices which may be transformed by being bent or rolled.

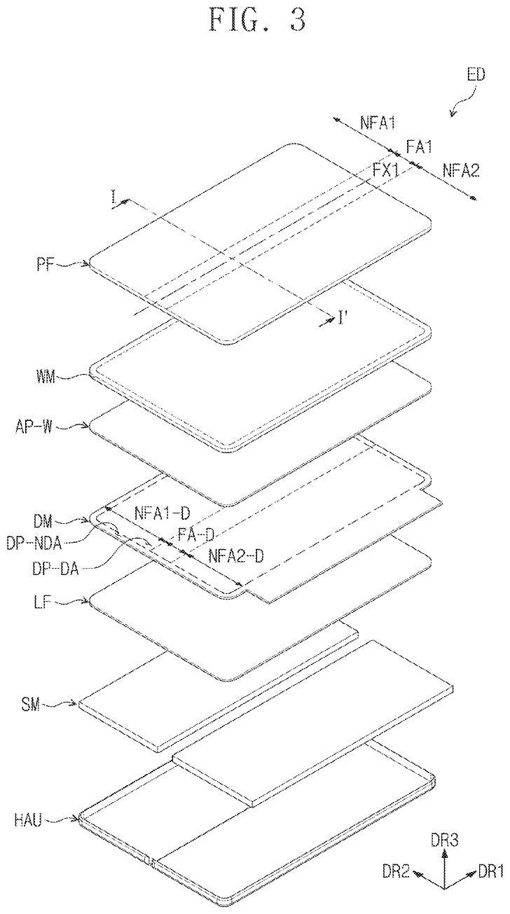

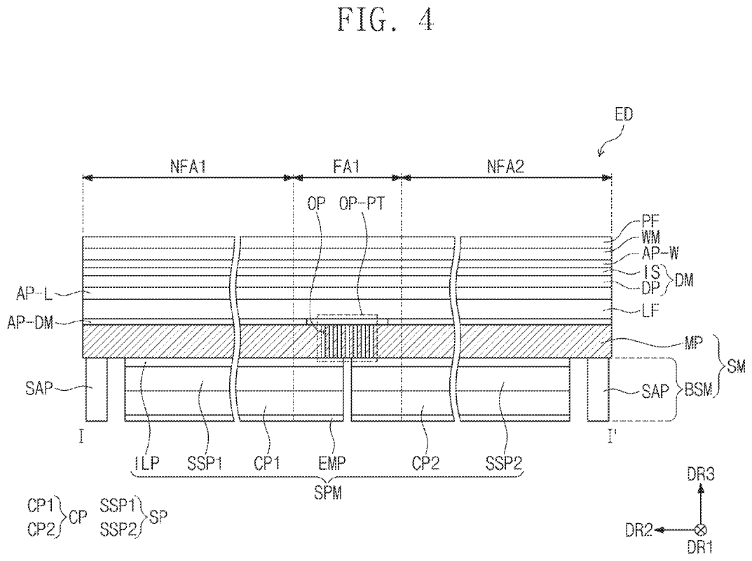

FIG. 3 is an exploded perspective view of the display device according to an embodiment, and FIG. 4 is a cross-sectional view of the display device according to an embodiment. FIG. 3 exemplarily illustrates the exploded perspective view of the display device according to an embodiment illustrated in FIG. 1A. FIG. 4 is the cross-sectional view illustrating a part taken along line I-I′ of FIG. 3.

Referring to FIGS. 3 and 4, the display device ED of an embodiment may include a display module DM, and a window WM disposed on the upper portion of the display module DM. In addition, the display device ED of an embodiment may include a support module SM disposed on the lower portion of the display module DM, and a protective layer PF disposed on the upper portion of the window WM. In an embodiment, the protective layer PF may be omitted. With reference to FIGS. 3 and 4, the display device ED illustrated in FIGS. 1A to 1C has been described as an embodiment, but the following description may also be equally applied to the display device ED-a illustrated in FIGS. 2A and 2B.

The window WM may cover the entire outside of the display module DM. The window WM may have a shape corresponding to the shape of the display module DM. In addition, the display device ED of an embodiment may include a housing HAU accommodating the display module DM and the support module SM. The housing HAU may be coupled to the window WM. Although not illustrated, the housing HAU may further include a hinge structure for facilitating folding or bending.

In the display device ED of an embodiment, the display module DM may display an image in response to an electrical signal and may transmit or receive information on an external input. The display module DM may be defined as a display region DP-DA and a non-display region DP-NDA. The display region DP-DA may be defined as a region emitting an image provided from the display module DM.

The non-display region DP-NDA is adjacent to the display region DP-DA. For example, the non-display region DP-NDA may surround the display region DP-DA. However, this is exemplarily illustrated, and the non-display region DP-NDA may have various shapes, and is not limited to any one embodiment. According to an embodiment, the display region DP-DA of the display module DM may correspond to at least a portion of the active region F-AA (see FIG. 1A).

In the display device ED according to an embodiment, the display module DM may include a folding display part FA-D and non-folding display parts NFA1-D and NFA2-D. The folding display part FA-D may correspond to the folding region FA1 (see FIG. 1A), and the non-folding display parts NFA1-D and NFA2-D may correspond to the non-folding regions NFA1 and NFA2 (see FIG. 1A).

The window WM according to an embodiment is disposed on the display module DM. The window WM may include or may be formed of an optically transparent insulating material. The window WM may protect the display panel DP and the sensor layer IS. That is, the window WM may be a cover window that covers the upper portion of the display module DM.

The image IM (see FIG. 1A) generated in the display panel DP may be provided to a user by being transmitted through the window WM. The window WM may provide a touch surface of the display device ED. In the display device ED including the folding region FA1, the window WM may be a foldable flexible window.

The window WM may be provided as a display surface and a touch surface, and exhibit excellent optical properties. The window WM of an embodiment may have a high transmittance of 90% or more in a visible light region of about 380 nm to about 780 nm. Terms such as “about” or “approximately” may reflect amounts, sizes, orientations, or layouts that vary only in a small relative manner, and/or in a way that does not significantly alter the operation, functionality, or structure of certain elements. For example, a range from “about 0.1 to about 1” may encompass a range such as a 0%-5% deviation around 0.1 and a 0% to 5% deviation around 1, especially if such deviation maintains the same effect as the listed range.

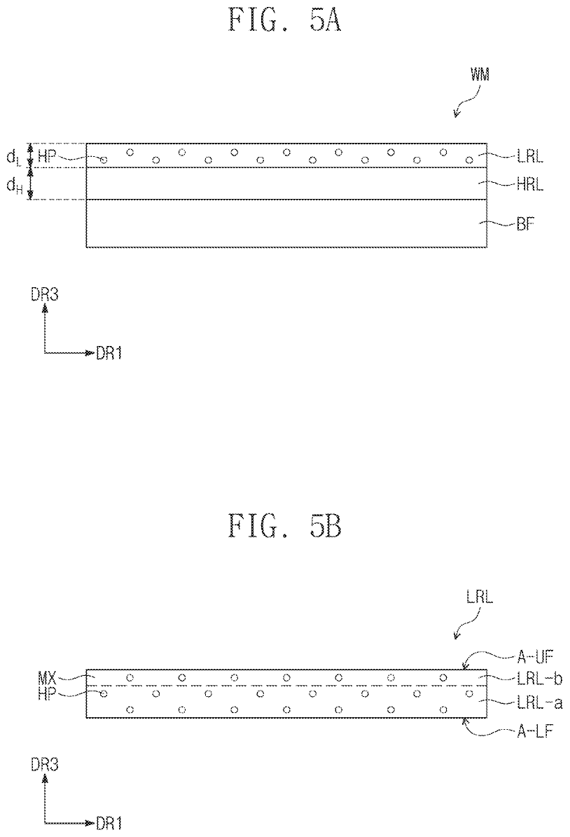

The window WM of an embodiment may include a base layer BF (see FIG. 5A) in the film form having flexibility, a high refractive layer HRL (see FIG. 5A) disposed on the base layer BF (see FIG. 5A), and a low refractive layer LRL (see FIG. 5A) disposed on the high refractive layer HRL (see FIG. 5A). The window WM of an embodiment will be described later in more detail.

The display module DM may include a display panel DP and a sensor layer IS disposed on the display panel DP. In addition, although not illustrated, the display module DM may further include an optical layer (not shown) disposed on the sensor layer IS. The optical layer (not shown) may serve to reduce reflection due to external light. For example, the optical layer (not shown) may include a polarizing layer or a color filter layer.

The display panel DP may be configured to substantially generate a video. For example, the display panel DP may be an organic light emitting display panel, an inorganic light emitting display panel, a quantum dot display panel, a micro LED display panel, a nano LED display panel, or a liquid crystal display panel. The display panel DP may be referred to as a display layer.

The sensor layer IS may be disposed on the display panel DP. The sensor layer IS may detect an external input applied from the outside. The external input may be a user's input. The user's input may include various types of external inputs such as a portion of a user's body, light, heat, a pen, and a pressure.

In the display module DM of an embodiment, the sensor layer IS may be formed on the display panel DP through a continuous process. In this case, the sensor layer IS may be directly disposed on the display panel DP. The expression “directly disposed” may mean that a third component is not disposed between the sensor layer IS and the display panel DP. That is, a separate adhesive member may not be disposed between the sensor layer IS and the display panel DP. Alternatively, in an embodiment of the present disclosure, the sensor layer IS may be coupled to the display panel DP through an adhesive member. The adhesive member may include or may be formed of a typical adhesive or pressure adhesive.

The protective layer PF may be disposed on the upper portion of the window WM. The protective PF may be a functional layer that protects the upper surface of the window WM.

The protective layer PF according to an embodiment may include or may be formed of at least one polymer resin among polyethylene terephthalate (PET), polybutylene terephthalate (PBT), polyethylene naphthalene (PEN), polycarbonate (PC), poly(methylmethacrylate) (PMMA), polystyrene (PS), polyvinylchloride (PVC), polyethersulfone (PES), polypropylene (PP), polyamide (PA), modified polyphenylene ether (m-PPO), polyoxymethylene (POM), polysulfone (PSU), polyphenylene sulfide (PPS), polyimide (PI), polyethyleneimine (PEI), polyether ether ketone (PEEK), polyamide imide (PAI), polyarylate (PAR), and thermoplastic polyurethane (TPU). The protective layer PF may be a polymer film layer, and for example, in an embodiment, the protective layer PF may be a polyethylene terephthalate (PET) film or a thermoplastic polyurethane (TPU) film.

Meanwhile, the display device ED of an embodiment may further include a protective adhesive layer (not shown). The protective adhesive layer (not shown) may be disposed between the window WM and the protective layer PF. The protective layer PF may be attached onto the window WM through the protective adhesive layer (not shown). The protective adhesive layer (not shown) may include or may be formed of a silicone-based resin, an acrylic-based resin, or a urethane-based resin. In addition, the protective layer PF may further include materials such as an anti-fingerprint coating agent, an antistatic agent, and a hard coating agent, thereby serving as a functional layer. Meanwhile, the protective layer PF may have a stacked multi-layer structure, and may further include a separate functional layer such as an anti-fingerprint coating layer, an antistatic coating layer, and a hard coating layer.

The window adhesive layer AP-W may be disposed between the window WM and the display module DM. The window adhesive layer AP-W may be an optically clear adhesive film (OCA) or an optically clear adhesive resin layer (OCR).

The display device ED of an embodiment may include a lower film LF disposed on the lower portion of the display module DM. The lower film LF may be disposed below the display module DM to protect the lower portion of the display panel DP. The display device ED of an embodiment may include a lower adhesive layer AP-L that couples the display module DM and the lower film LF with each other.

The lower film LF may be a polymer film. For example, the lower film LF may include or may be a polyethylene terephthalate (PET) film or a polyimide (PI) film. The lower film LF may prevent the rear surface of the display panel DP from being scratched during the manufacturing process of the display panel DP. In addition, the lower film LF protects the display panel DP against pressure provided from the outside, and thus may prevent deformation of the display panel DP. The lower film LF may have a structure having one film layer or a plurality of film layers that are stacked on each other.

The lower adhesive layer AP-L that may be disposed between the display panel DP and the lower film LF. The lower adhesive layer AP-L may be an optically clear adhesive film (OCA) or an optically clear adhesive resin layer (OCR). However, the embodiment of the present disclosure is not limited thereto, and the lower adhesive layer AP-L may include or may be formed of an acrylic-based adhesive, or a silicone-based adhesive. In addition, in an embodiment, the lower adhesive layer AP may be omitted.

The display device ED according to an embodiment may include the support module SM disposed on the lower portion of the display module DM. The support module SM may include a support plate MP and a lower support member BSM.

The support plate MP may be disposed on the lower portion of the display module DM. In an embodiment, the support plate MP may include or may be formed of a metal material or a polymer material. For example, the support plate MP may include or may be formed of stainless steel, aluminum, or an alloy thereof. In addition, the support plate MP may be formed of carbon fiber reinforced plastic (CFRP). However, the embodiment of the present disclosure is not limited thereto, and the support plate MP may include or may be formed of a non-metal material such as plastic, glass fiber reinforced plastic, and glass.

A plurality of openings OP may be defined in the support plate MP. The support plate MP may include an opening pattern OP-PT containing a plurality of openings OP. The opening pattern OP-PT may correspond to the folding region FA1.

The lower support member BSM may include a support member SPM and a filling part SAP. The support member SPM may overlap most of the display module DM. The filling part SAP may be disposed outside the support member SPM and overlap the outer part of the display module DM.

The lower support member BSM may include at least one of a support layer SP, a cushion layer CP, a shielding layer EMP, and an interlayer bonding layer ILP. Meanwhile, the configuration of the lower support member BSM is not limited to the configuration illustrated in FIG. 4 and the configuration of the lower support member BSM may vary depending on the size and shape of the display device ED, and the operating characteristics of the display device ED. For example, some of the support layer SP, the cushion layer CP, the shielding layer EMP, and the interlayer bonding layer ILP may be omitted, the stacking order thereof may be modified in a different order from that of FIG. 4, or additional components other than the illustrated configuration may be further included. For example, the lower support member BSM may further include a digitizer.

The support layer SP may include or may be formed of a metal material or a polymer material. The support layer SP may be disposed on the lower portion of the support plate MP. For example, the support layer SP may be a thin-film metallic substrate.

The support layer SP may include a first sub-support layer SSP1 and a second sub-support layer SSP2 which are spaced apart from each other in the second direction DR2. The first sub-support layer SSP1 and the second sub-support layer SSP2 may be spaced apart from each other with respect to a part corresponding to the folding axis FX1. For example, the support layer SP is spaced apart from each other in the folding region FA1 and is provided as the first sub-support layer SSP1 and the second sub-support layer SSP2, thereby improving folding or bending characteristics of the display device ED.

The cushion layer CP may be disposed on the lower portion of the support layer SP. The cushion layer CP may prevent plastic deformation and a pressed phenomenon of the support plate MP caused by an external impact and force. The cushion layer CP may improve impact resistance of the display device ED. The cushion layer CP may include or may be formed of an elastomer such as sponge, foam, and a urethane resin. In addition, the cushion layer CP may include or may be formed of at least one of an acrylic-based polymer, a urethane-based polymer, a silicone-based polymer, and an imide-based polymer. However, the embodiment of the present disclosure is not limited thereto.

In addition, the cushion layer CP may include a first sub-cushion layer CP1 a second sub-cushion CP2 which are spaced apart from each other in the second direction DR2. The first sub-cushion layer CP1 and the second sub-cushion layer CP2 may be spaced apart from each other with respect to a part corresponding to the folding axis FX1. For example, the cushion layer CP is spaced apart from each other in the folding region FA1 and is provided as the first sub-cushion layer CP1 and the second sub-cushion layer CP2, thereby improving folding or bending characteristics of the display device ED.

The shielding layer EMP may be an electromagnetic wave shielding layer or a heat dissipating layer. In addition, the shielding layer EMP may function as a bonding layer. The interlayer bonding layer ILP may bond the support plate MP and the lower support member BSM with each other. The interlayer bonding layer ILP may be provided in the form of a bonding resin layer or an adhesion tape. Although FIG. 3 illustrates that the interlayer bonding layer ILP is divided into two parts spaced apart from each other in a part corresponding to the folding region FA1, the embodiment of the present disclosure is not limited thereto, and the interlayer bonding layer ILP may be provided as a single layer, parts of which are not spaced apart from each other, in the folding region FA1.

The filling part SAP may be disposed on the outer part of the support layer SP and the cushion layer CP. The filling part SAP may be disposed between the support plate MP and the housing HAU. The filling part SAP may fill a space between the support plate MP and the housing HAU, and fix the support plate MP.

In addition, the display device ED of an embodiment may further include a module adhesive layer AP-DM disposed between the display module DM and the support module SM. The module adhesive layer AP-DM may be an optically clear adhesive film (OCA) or an optically clear adhesive resin layer (OCR). Meanwhile, although not illustrated, an adhesive layer may be further disposed between two adjacent members included in the support module SM.

The display device ED of an embodiment as described with reference to FIGS. 1A to 4 may include a display module DM, and a window WM disposed on the display module DM, and include at least one folding region.

Meanwhile, the structure of the display device of an embodiment is not limited to the illustrated structure. In some embodiments, the display device may include a plurality of folding regions. The extending direction of the folding axis with respect to which the display device is folded is not limited to the illustrated direction. In some embodiments, the extending direction of the folding axis may extend in various directions. In addition, the display device of an embodiment may be a flexible display device in which at least a portion of region may be bent or rolled.

FIG. 5A is a cross-sectional view illustrating a window according to an embodiment of the present disclosure. FIG. 5B is a cross-sectional view illustrating a low refractive layer of a window according to an embodiment of the present disclosure. FIG. 5A may illustrate the window WM of an embodiment illustrated in FIGS. 3 and 4. The window WM of an embodiment illustrated in FIG. 5A may be used as a cover window of the display device ED or ED-a of an embodiment described with reference to FIGS. 1A to 4.

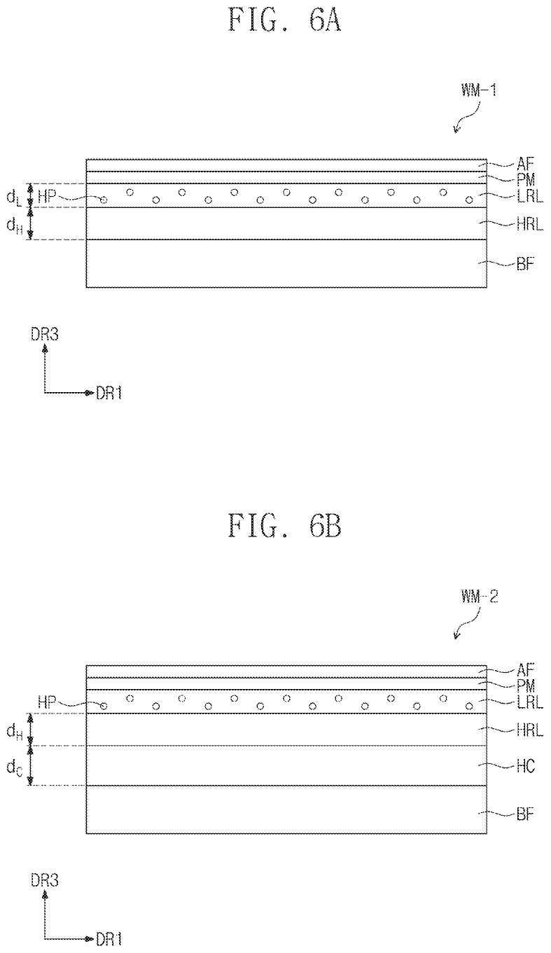

Referring to FIG. 5A, the window WM of an embodiment may include a base layer BF, a high refractive layer HRL disposed on the base layer BF, and a low refractive layer LRL disposed on the high refractive layer HRL. Hereinafter, the descriptions of the base layer BF, the high refractive layer HRL, and the low refractive layer LRL included in the window WM may be equally applied to the windows WM-1 and WM-2 of an embodiment as described with reference to FIGS. 6A and 6B as well as the window WM of an embodiment illustrated in FIG. 5A.

The base layer BF according to an embodiment may be formed of a polymer material. The base layer BF may be a flexible polymer film. In the window WM of an embodiment, the base layer BF may be a polymer film layer. The base layer BF may include or may be formed of at least one of polyimide (PI), polyethylene terephthalate (PET), polyamide (PA), polycarbonate (PC), and triacetyl cellulose (TAC). However, the embodiment of the present disclosure is not limited thereto, and the base layer BF may be used without limitation as long as it is optically transparent and flexible. For example, the window WM according to an embodiment may include or may be formed of a polyethylene terephthalate film as the base layer BF. When the base layer BF in the window WM according to an embodiment includes the above-described polyethylene terephthalate film, the window WM may exhibit excellent optical properties such as low haze and high transmittance.

The base layer BF may have a thickness of about 50 μm to about 100 μm. When the thickness of the base layer BF is less than about 50 μm, the base layer BF may not serve as a support layer on which the high refractive layer HRL is provided nor serve to protect the display module DM (see FIG. 3) therebelow. In addition, when the thickness of the base layer BF is greater than 100 μm, the entire thickness of the display device ED (see FIG. 3) may be increased.

In particular, when the display devices ED and ED-a are folded as illustrated in FIGS. 1A to 2B, the greater the thickness of the base layer BF, the lower the folding properties may be.

The window WM of an embodiment may include or may be formed of a single base layer BF. In the window WM of an embodiment, the base layer BF may be a single polymer film layer. However, the embodiment of the present disclosure is not limited thereto, and the base layer BF may be provided in the form in which a plurality of polymer films are stacked in the window WM of an embodiment. When the base layer BF is provided by stacking a plurality of polymer films, the plurality of polymer films may include or may be formed of the same type of polymer material, or the plurality of polymer films may be formed of different polymer materials.

The high refractive layer HRL may be disposed on the base layer BF. The high refractive layer HRL may be directly disposed on the base layer BF. The lower surface of the high refractive layer HRL may be in contact with the upper surface of the base layer BF.

The high refractive layer HRL may include a first polymer derived from a first resin composition. The first resin composition may contain a highly stretchable material. The first resin composition may further contain a first base resin. The first base resin may include or may be formed of an acrylic-based resin, a urethane-based resin, a fluorine-based resin, an epoxy-based resin, a polyester-based resin, a polyamide-based resin, a silicone-based resin, or a combination thereof.

Meanwhile, in the specification, the term “substituted or unsubstituted” may mean that one is substituted or unsubstituted with at least one substituent selected from the group consisting of a deuterium atom, a halogen atom, a cyano group, a nitro group, an amino group, a silyl group, an oxy group, a thio group, a sulfinyl group, a sulfonyl group, a carbonyl group, a boron group, a phosphine oxide group, a phosphine sulfide group, an alkyl group, an alkenyl group, an alkynyl group, a hydrocarbon ring group, an aryl group, and a heterocyclic group. In addition, each of the substituents exemplified above may be substituted or unsubstituted. For example, a biphenyl group may be interpreted as an aryl group or a phenyl group substituted with a phenyl group.

In the specification, the alkyl group may be linear or branched. The number of carbons in the alkyl group is 1 to 50, 1 to 30, 1 to 20, 1 to 10, or 1 to 6. Examples of the alkyl group may include or may be formed of a methyl group, an ethyl group, an n-propyl group, an isopropyl group, an n-butyl group, an s-butyl group, a t-butyl group, an i-butyl group, a 2-ethylbutyl group, a 3,3-dimethylbutyl group, an n-pentyl group, an i-pentyl group, a neopentyl group, a t-pentyl group, a 1-methylpentyl group, a 3-methylpentyl group, a 2-ethylpentyl group, a 4-methyl-2-pentyl group, an n-hexyl group, a 1-methylhexyl group, a 2-ethylhexyl group, a 2-butylhexyl group, an n-heptyl group, a 1-methylheptyl group, a 2,2-dimethylheptyl group, a 2-ethylheptyl group, a 2-butylheptyl group, an n-octyl group, a t-octyl group, a 2-ethyloctyl group, a 2-butyloctyl group, a 2-hexyloctyl group, a 3,7-dimethyloctyl group, an n-nonyl group, an n-decyl group, an adamantyl group, a 2-ethyldecyl group, a 2-butyldecyl group, a 2-hexyldecyl group, a 2-octyldecyl group, an n-undecyl group, an n-dodecyl group, a 2-ethyldodecyl group, a 2-butyldodecyl group, a 2-hexyldocecyl group, a 2-octyldodecyl group, an n-tridecyl group, an n-tetradecyl group, an n-pentadecyl group, an n-hexadecyl group, a 2-ethylhexadecyl group, a 2-butylhexadecyl group, a 2-hexylhexadecyl group, a 2-octylhexadecyl group, an n-heptadecyl group, an n-octadecyl group, an n-nonadecyl group, an n-eicosyl group, a 2-ethyleicosyl group, a 2-butyleicosyl group, a 2-hexyleicosyl group, a 2-octyleicosyl group, an n-henicosyl group, an n-docosyl group, an n-tricosyl group, an n-tetracosyl group, an n-pentacosyl group, an n-hexacosyl group, an n-heptacosyl group, an n-octacosyl group, an n-nonacosyl group, or an n-triacontyl group, but the embodiment of the present disclosure is not limited thereto.

In the specification, a fluoroalkyl group refers to an alkyl group in which at least one hydrogen atom is substituted with a fluorine atom. The number of carbon atoms in the fluoroalkyl group may be 1 to 30, 1 to 20, or 1 to 10.

In the specification, a perfluoroalkyl group refers to an alkyl group in which all the hydrogen atoms in the alkyl group are substituted with fluorine atoms. The perfluoroalkyl group may synthetic chemicals included in the fluoroalkyl group. The number of carbon atoms in the perfluoroalkyl group may be 1 to 30, 1 to 20, or 1 to 10. The perfluoroalkyl group may have the structure of Formula F-1 below, but the embodiment of the present disclosure is not limited thereto.

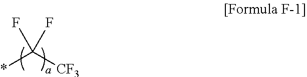

In Formula F-1, the subscript number of “a” may be an integer of 0 to 30.

Meanwhile, “ [symbol] ” herein means a position to be linked.

In an embodiment, the highly stretchable material may be represented by Formula A-1 or Formula A-2 below:

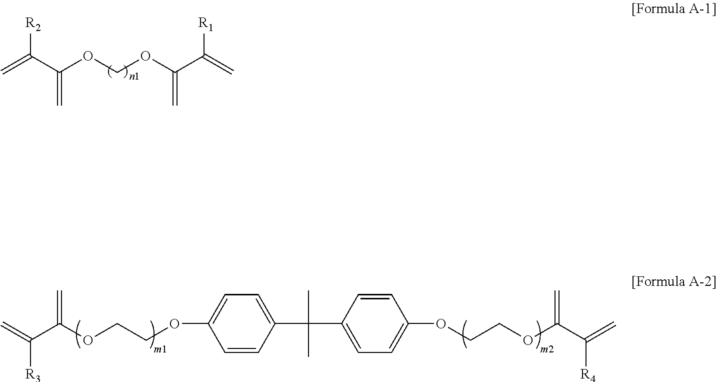

In Formula A-1 and Formula A-2, R₁ to R₄ may be each independently a hydrogen atom, or a substituted or unsubstituted methyl group. In an embodiment, R₁ to R₄ may be each independently a hydrogen atom or an unsubstituted methyl group. For example, R₁ to R₄ may be each independently a hydrogen atom. For example, R1 may be selected from a hydrogen atom, a substituted methyl group, and an unsubstituted methyl group. Irrespective of the selection of R1, R2 may be selected from a hydrogen atom, a substituted methyl group, and an unsubstituted methyl group. Irrespective of selection of R1 and R2, R3 may be selected from a hydrogen atom, a substituted methyl group, and an unsubstituted methyl group. Irrespective of selection of R1 to R3, R4 may be selected from a hydrogen atom, a substituted methyl group, and an unsubstituted methyl group.

In Formula A-1, the subscript number of “n1” is an integer of 6 to 10.

In Formula A-2, the subscript numbers of “m1” and “m2” are each independently an integer of 1 to 20, and the sum of ml and m2 is 30 or less. For example, the sum of m1 and m2 may be 10 or 30. For example, ml may be an integer selected from a range of 1 to 20. Irrespective of selection of ml, m2 may be an integer selected from a range of 1 to 20.

In an embodiment, the highly stretchable material represented by Formula A-1 may be represented by Formula A-1-1 or Formula A-1-2 below:

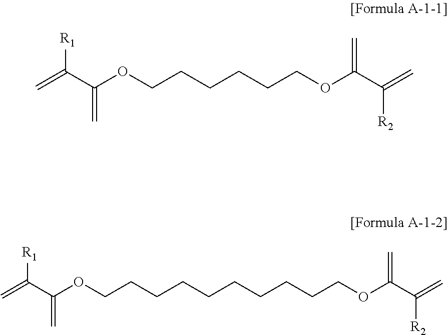

Formula A-1-1 and Formula A-1-2 represent the cases where the subscript number of “n1” is specified in Formula A-1. Formula A-1-1 means the case where n1 is 6 in Formula A-1. That is, Formula A-1-1 means 1,6-hexanediol di(meth)acrylate. Formula A-1-2 means the case where n1 is 10 in Formula A-1. That is, Formula A-1-2 means 1,10-decanediol di(meth)acrylate.

In Formula A-1-1 and Formula A-1-2, the same as described in Formula A-1 may be applied to R₁ and R₂.

In an embodiment, the highly stretchable material represented by Formula A-2 may be represented by Formula A-2-1 or Formula A-2-2 below:

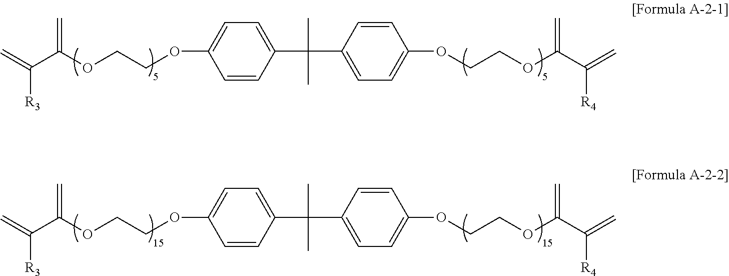

In Formula A-2-1 and Formula A-2-2, the same as described in Formula A-2 may be applied to R₃ and R₄.

In an embodiment, the high refractive layer HRL may be formed by providing the first resin composition on the base layer BF with a method such as coating and curing the first resin composition. The high refractive layer HRL may be formed by thermally curing or photo-curing the first resin composition. In an embodiment, the high refractive layer HRL may be formed by photo-curing.

The high refractive layer HRL may include or may be formed of the first polymer derived from the first resin composition containing the highly stretchable material, thereby increasing the hardness and impact resistance of the window WM. In addition, the high refractive layer HRL of an embodiment may protect the window WM from an external impact, or chemical damage.

The high refractive layer HRL may include or may be formed of a highly stretchable polymer compound. In an embodiment, the highly stretchable polymer compound of the high refractive layer HRL may include a condensate of the highly stretchable material and the first base resin. When the high refractive layer HRL includes or is formed of the highly stretchable polymer compound, the high refractive layer HRL may have excellent hardness and flexibility characteristics.

When the first resin composition according to an embodiment includes or is formed of the highly stretchable material represented by Formula A-1, the first resin composition may include about 5 wt % or less of the highly stretchable material with respect to the total amount of the first resin composition. That is, in the first resin composition according to an embodiment, the highly stretchable material represented by Formula A-1 may be included in an amount of about 5 wt % or less with respect to the total amount of the first resin composition. For example, the highly stretchable material represented by Formula A-1 may be included in an amount of about 0.1 wt % to about 5 wt % with respect to the total amount of the first resin composition. When the highly stretchable material represented by Formula A-1 is included in an amount of about 5 wt % or less with respect to the total amount of the first resin composition, the coatability and curing reactivity of the first resin composition may be improved, and the durability of the window WM may be improved.

When the first resin composition according to an embodiment includes or is formed of the highly stretchable material represented by Formula A-2, the first resin composition may include about 5 wt % to about 10 wt % of the highly stretchable material with respect to the total amount of the first resin composition. That is, in the first resin composition according to an embodiment, the highly stretchable material represented by Formula A-2 may be included in an amount of about 5 wt % to about 10 wt % with respect to the total amount of the first resin composition. When the highly stretchable material represented by Formula A-2 is included in an amount of about 5 wt % to about 10 wt % with respect to the total amount of the first resin composition, the coatability and curing reactivity of the first resin composition may be improved, and the durability of the window WM may be improved.

The first resin composition may further contain at least any one additive selected from among a filler, a slip agent, a light stabilizer, a thermal polymerization inhibitor, a leveling agent, a lubricant, an antifouling agent, a thickener, a surfactant, an antifoaming agent, an antistatic agent, a dispersant, an initiator, a coupling agent, an antioxidant, a UV stabilizer, and a colorant.

The high refractive layer HRL according to an embodiment may further include inorganic particles. The high refractive layer HRL according to an embodiment may further include inorganic particles to increase the hardness of the high refractive layer HRL. The high refractive layer HRL may further include at least one of a tin oxide (SnOₓ), a titanium oxide (TiOₓ), a zirconium oxide (ZrOₓ), and a sulfur atom. Meanwhile, in the tin oxide, the titanium oxide, and the zirconium oxide included in the high refractive layer HRL, X may satisfy 0<X<3 in SnOₓ, TiOₓ, and ZrOₓ. For example, the tin oxide may be SnO₂, but the embodiment of the present disclosure is not limited thereto.

The high refractive layer HRL may have a greater refractive index than the low refractive layer LRL. The high refractive layer HRL may have a refractive index of about 1.52 to about 1.67. As the refractive index of the high refractive layer HRL of an embodiment satisfies the above range, the surface reflectance of the window WM may be reduced.

In an embodiment, the thickness d_{H} of the high refractive layer HRL may be about 3,000 nm to about 5,000 nm. When the high refractive layer HRL has a thickness range of about 3,000 nm to about 5,000 nm, the window WM of an embodiment may exhibit excellent optical properties such as high transmittance and low reflectance. In addition, the window WM of an embodiment including the high refractive layer HRL having a thickness range of about 3,000 nm to about 5,000 nm may have excellent impact resistance and may exhibit improved durability.

The low refractive layer LRL may be disposed on the high refractive layer HRL. The low refractive layer LRL may be directly disposed on the high refractive layer HRL. The lower surface of the low refractive layer LRL may be in contact with the upper surface of the high refractive layer HRL. The low refractive layer LRL may be disposed on the base layer BF, and the low refractive layer LRL may be disposed on the base layer BF that is closer to the display surface FS (see FIG. 1A) that is exposed to the outside. However, the embodiment of the present disclosure is not limited thereto.

The refractive index of the low refractive layer LRL may be adjusted according to a combination of the refractive index of the base layer BF and the high refractive layer HRL so that the reflectance of the entire window WM is about 6% or less. The reflectance of the window

WM including the low refractive layer LRL with respect to light having a wavelength of about 360 nm to about 700 nm may be about 6% or less.

The refractive index of the low refractive layer LRL is smaller than the refractive index of the high refractive layer HRL, and for example, the refractive index of the low refractive layer LRL may be about 1.42 to about 1.50. However, the embodiment of the present disclosure is not limited thereto, and the refractive index of the low refractive layer LRL may be adjusted within a range in which the window WM maintains a low reflectance characteristic of 6% or less.

The window WM according to the present disclosure includes a two-layered structure in which a layer having a relatively high refractive index and a layer having a relatively low refractive index are sequentially stacked with respect to the third direction DR3. Accordingly, an improved anti-reflection effect may be achieved.

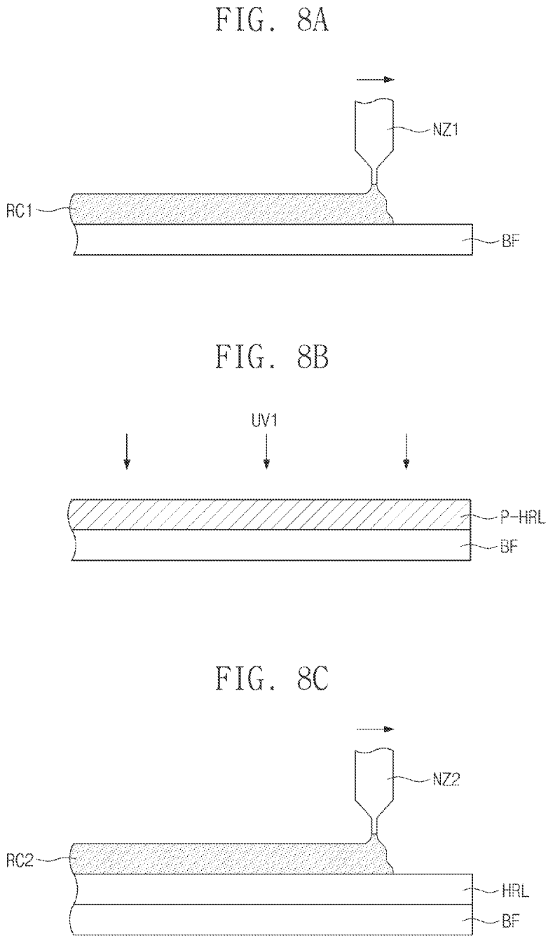

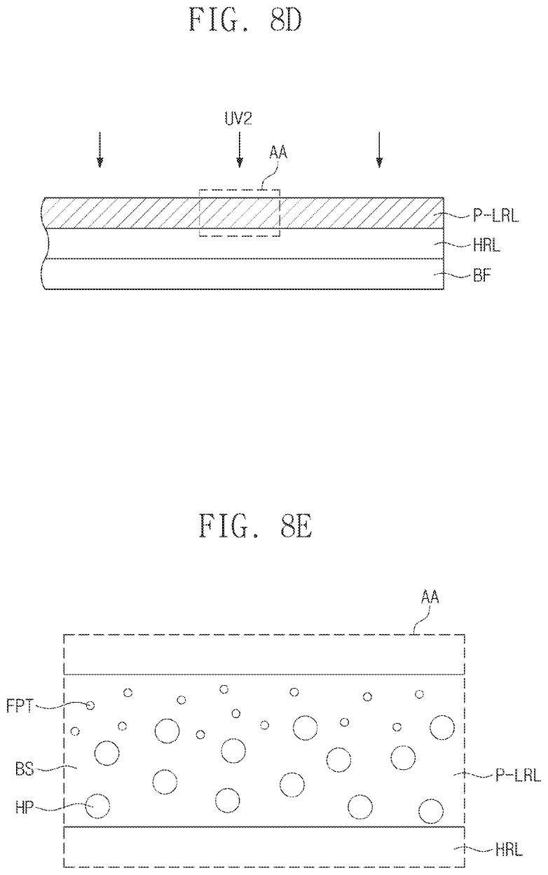

The low refractive layer LRL may include a second polymer derived from a second resin composition. The second resin composition may contain hollow particles HP and a first initiator including fluorine. The first initiator is contained in the second resin composition, and may function to improve the surface durability of the low refractive layer LRL when the low refractive layer LRL is formed. Since the second resin composition contains the first initiator including fluorine, the curing efficiency of the upper surface may be improved as the first initiator having a low surface energy in the curing process moves to the upper portion of a preliminary low refractive layer P-LRL (see FIG. 8E) which will be described later. Accordingly, the low refractive layer LRL formed from the second resin composition of an embodiment may have excellent surface durability and may be applied to the window WM, thereby exhibiting improved abrasion resistance and chemical resistance characteristics.

The second resin composition may further contain a second base resin in addition to the hollow particles HP and the first initiator including fluorine. The second base resin may include or may be formed of an acrylic-based resin, a urethane-based resin, a fluorine-based resin, an epoxy-based resin, a polyester-based resin, a polyamide-based resin, a silicone-based resin, or a combination thereof.

The low refractive layer LRL according to an embodiment may be formed by applying the second resin composition on the base layer BF and curing the same. In some embodiments, the low refractive layer LRL may be formed by applying the second resin composition on a layer as serving as a substrate and curing the same. The low refractive layer LRL may be formed by applying the second resin composition on the high refractive layer HRL and curing the same. In an embodiment, the low refractive layer LRL may be formed by applying the second resin composition including the hollow particles HP, the first initiator, and the second base resin on the high refractive layer HRL and photo-curing the same.

The first initiator may contain at least two functional groups. The first initiator may contain a first functional group that polymerizes with at least the second base resin, and a second functional group substituted with fluorine. The first functional group may refer to a chemical functional group that may be decomposed by light or heat to emit radicals. That is, the first functional group may refer to a functional group capable of initiating a free radical polymerization reaction by light or heat. The second functional group may be fluoroalkyl or perfluoroalkyl.

In an embodiment, the first initiator may be represented by Formula M below. However, the structure of the first initiator is not limited to Formula M below.

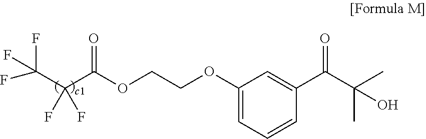

In Formula M, c1 is an integer of 1 to 10. For example, c1 may be 6.

In an embodiment, the first initiator in the second resin composition may be contained in an amount of about 5 wt % or less with respect to the total amount of the second resin composition. For example, the first initiator may be contained in an amount of about 0.1 wt % to about 5 wt % with respect to the total amount of the second resin composition. When the first initiator is contained in an amount of about 0.1 wt % to about 5 wt % with respect to the total amount of the second resin composition, the curing efficiency of the second resin composition is excellent, and the deterioration in the physical properties of the low refractive layer LRL due to the residual component after curing can be minimized. Accordingly, the low refractive layer LRL according to an embodiment may exhibit excellent hardness.

The second resin composition according to an embodiment may further contain a second initiator different from the first initiator. The second initiator may be a photoinitiator or a thermal initiator. For example, the second initiator may be a photoinitiator.

The second resin composition may further contain at least any one additive selected from among a filler, a slip agent, a light stabilizer, a thermal polymerization inhibitor, a leveling agent, a lubricant, an antifouling agent, a thickener, a surfactant, an antifoaming agent, an antistatic agent, a dispersant, an initiator, a coupling agent, an antioxidant, a UV stabilizer, and a colorant.

The low refractive layer LRL may include or may be formed of a fluorine-containing compound. The fluorine-containing compound may be derived from the first initiator. The fluorine-containing compound may be a compound containing fluorine. The fluorine- containing compound may be bonded to the second base resin contained in the second resin composition. The fluorine-containing compound may be bonded to the second base resin contained in the second resin composition to constitute a matrix MX.

Referring back to FIG. 5B, the low refractive layer LRL may include an upper surface A-UF and a lower surface A-LF facing the upper surface A-UF. The lower surface A-LF of the low refractive layer LRL may be adjacent to the base layer BF (see FIG. 5A). The lower surface A-LF of the low refractive layer LRL may be opposite to the upper surface A-UF of the low refractive layer LRL in the third direction DR3.

In an embodiment, a concentration distribution of fluorine in the low refractive layer LRL may be non-uniform. In the low refractive layer LRL, the overall concentration of fluorine may increase from the lower surface A-LF toward the upper surface A-UF. That is, the low refractive layer LRL may have a concentration distribution in which the content of fluorine increases from the lower surface A-LF of the low refractive layer LRL toward the upper surface A-UF thereof.

The low refractive layer LRL of an embodiment may include a first low refractive layer LRL-a and a second low refractive layer LRL-b. In the low refractive layer LRL, the first low refractive layer LRL-a and the second low refractive layer LRL-b may be divided according to the concentration of fluorine. The concentration of fluorine in the second low refractive layer LRL-b may be greater than the concentration of fluorine in the first low refractive layer LRL-a. In an embodiment, the first low refractive layer LRL-a may be a portion that does not contain fluorine. However, the embodiment of the present disclosure is not limited thereto. The first low refractive layer LRL-a and the second low refractive layer LRL-b may not be layers separated from each other with a separate interface therebetween, but may have an integral shape. The present disclosure is not limited thereto. For example, the first low refractive layer LRL-a and the second low refractive layer LRL-b may be layers divided by a difference in the fluorine concentration.

According to an embodiment of the present disclosure, a first concentration of fluorine included in the second low refractive layer LRL-b may be greater than a second concentration of fluorine included in the first low refractive layer LRL-a. That is, the number of fluorine atoms included in the second low refractive layer LRL-b may be greater than the number of fluorine atoms included in the first low refractive layer LRL-a. The first concentration of fluorine included in the second low refractive layer LRL-b may be greater than about 50% and less than or equal to about 95% of the total concentration of fluorine included in the low refractive layer LRL. As the concentration of fluorine in the second low refractive layer LRL-b is high, the second low refractive layer LRL-b may have low surface energy.

Referring to FIG. 5B, the low refractive layer LRL may include the hollow particles HP. With respect to the total weight of the second resin composition, the amount of the hollow particles HP may be about 25 wt % to about 35 wt %. When the amount of hollow particle HP contained in the second resin composition satisfies the above-described range, the mechanical durability of the low refractive layer LRL formed later may be improved and the low reflection characteristics may be sufficiently secured. That is, when the hollow particles HP are contained in the low refractive layer LRL in an amount of about 25 wt % to about 35 wt % with respect to the entire low refractive layer LRL, the window WM of an embodiment may exhibit more improved optical properties and durability.

With respect to the total weight of the second resin composition, when the amount of the hollow particles HP is less than about 25 wt %, a refractive index value of the low refractive layer LRL formed later may be increased, and thus the light extraction function of the low refractive layer LRL may be deteriorated in relation to other members. In addition, when the amount of the hollow particles HP is greater than about 35 wt % with respect to the total weight of the second resin composition, the amount of the hollow particles HP contained in the low refractive layer LRL may be relatively increased, and thus the mechanical strength of the low refractive layer LRL may be deteriorated.

The low refractive layer LRL may include the matrix MX which disperses the hollow particles HP. The matrix MX may include a condensate of the first initiator and the second base resin. The matrix MX may be formed by mixing and providing the second resin composition containing the hollow particles HP, the first initiator, and the second base resin, and then solidifying the first initiator and the second base resin in a curing process.

The hollow particles HP may be in a core-shell shape. The hollow particles HP may include a core and a shell surrounding the core. The core may be defined by the shell. The shell may be a layer formed of an inorganic material. The shell may contain or may be formed of SiO₂. That is, in the low refractive layer LRL of an embodiment, the hollow particles HP may be hollow silica.

The core may be filled with air. Meanwhile, the embodiment of the present disclosure is not limited thereto, and the core in the hollow particles HP may be filled with a liquid or gas having a low refractive characteristic.

The shell may be surface-treated with a coupling agent. The outer surface of the shell in contact with the matrix MX may be treated with a coupling agent. The coupling agent may contain two functional groups. The coupling agent may contain a first end bonded to the shell of the hollow particles HP and a second end bonded to the matrix MX. The first end may be chemically bonded to the shell, and the second end may be chemically bonded to the matrix MX. In an embodiment, the first end may be an alkoxysilane group, and the second end may be a (meth)acryloxy group, an epoxy group, an amino group, or isocyanate. Since the coupling agent contains the first end and the second end, the interaction between the hollow particles HP and the matrix MX may be improved, and thus, the mechanical durability of the low refractive layer LRL may be improved.

The shell of the hollow particles HP may contain a silanol group on the surface thereof. In the specification, the silanol group may refer to a substituent having a structure in which a hydroxyl group is linked to a silicon atom. That is, the silanol group may be represented by Si—OH. Accordingly, in the case of the resin composition containing the hollow particles HP, there is a limitation in that it is difficult to process the resin composition because of a decrease in dispersibility due to a property of agglomeration between adjacent hollow particles HP. As the hollow particles HP are surface-treated, the interaction between the adjacent hollow particles HP is reduced, and the interaction between the hollow particles HP and the matrix MX is improved, such that the durability of the low refractive layer LRL may be further improved.

The hollow particles HP may have an average diameter of about 90 nm or less. Specifically, the hollow particles HP may have an average diameter of about 50 nm to about 90 nm. By setting the average diameter of the hollow particles HP to about 50 nm to about 90 nm, the thickness and the refractive index value of the low refractive layer LRL may have a desirable property.

In an embodiment, the thickness d_{L} of the low refractive layer LRL may be about 50 nm to about 90 nm. When the low refractive layer LRL has a thickness range of about 50 nm to about 90 nm, the window WM of an embodiment may exhibit excellent optical properties such as high transmittance and low reflectance. In addition, the window WM of an embodiment including the low refractive layer LRL having a thickness range of about 50 nm to about 90 nm may have excellent impact resistance and exhibit improved durability.

The window WM of an embodiment may include the base layer BF, the high refractive layer HRL which is disposed on the base layer BF and includes the first polymer derived from the first resin composition containing the highly stretchable material, and the low refractive layer LRL which is disposed on the high refractive layer HRL and includes the second polymer derived from the second resin composition containing the hollow particles HP and the first initiator including fluorine, and thus may exhibit excellent optical properties, excellent durability, and good folding properties at the same time.

Each of FIGS. 6A and 6B is a cross-sectional view illustrating the window according to an embodiment of the present disclosure; FIGS. 6A and 6B may illustrate the window WM of an embodiment illustrated in FIGS. 3 and 4. Windows WM-1 and WM-2 of embodiments illustrated in FIGS. 6A and 6B may be used as a cover window of the display device ED or ED-a of an embodiment described with reference to FIGS. 1A to 4. Hereinafter, in describing the windows WM-1 and WM-2 according to an embodiment of the present disclosure with reference to FIGS. 6A and 6B, the same features as those described above with reference to FIGS. 5A and 5B will be omitted and differences will be described in detail.

Referring to FIG. 6A, the window WM-1 may further include a functional layer AF disposed on the low refractive layer LRL. In addition, the window WM-1 may further include an adhesive layer PM disposed between the low refractive layer LRL and the functional layer AF. That is, the window WM-1 illustrated in FIG. 6A is different from the window WM illustrated in FIG. 5A in that the window WM-1 further includes the functional layer AF and the adhesive layer PM. The description of the functional layers included in the window WM in FIG. 5A as described above may be equally applied to each of the functional layers included in the window WM-1 according to an embodiment illustrated in FIG. 6A.

In an embodiment, the functional layer AF may be disposed on the low refractive layer LRL. The functional layer AF may be disposed on the low refractive layer LRL. The functional layer AF may be disposed on the upper portion of the adhesive layer PM. The functional layer AF may be disposed on one surface of the base layer BF that is closer to the display surface FS (see FIG. 1A) exposed to the outside. The functional layer AF may be disposed at the outermost portion of the window WM-1.

The functional layer AF may be composed of a single layer or a plurality of layers. The functional layer AF may include or may be formed of at least one of a hard coating layer, an anti-fingerprint layer, and an anti-scattering layer. In an embodiment, the functional layer AF may include or may be formed of a fluorine-containing compound. In an embodiment, the functional layer AF including the fluorine-containing compound may be an anti-fingerprint layer.

The thickness of the functional layer AF may be about 10 nm to about 30 nm. When the thickness of the functional layer AF is about 10 nm to about 30 nm, the functional layer AF may exhibit excellent antifouling characteristics and excellent durability characteristics at the same time.

In an embodiment, the functional layer AF may include a perfluoropolyether (PFPE) compound. The functional layer AF may be formed from a condensation reaction of a functional layer composition including a PFPE compound. The PFPE compound may be a compound represented by Formula F-1 or Formula F-2 below.

A₁—L₁—M₁ [Formula F-1]

A₁—L₁M₂—L₂—A₂ [Formula F-2]

In Formula F-1 and Formula F-2, M₁ and M₂ may be each independently a PFPE group. For example, M₁ may be CF₃—(CF₂—CF₂—O)ₐ—(CF₂—O)_{b}—*. M₂ may be *—(CF₂—CF₂—O)ₐ—(CF₂—O)_{b}—*. For example, M₁ may be a chemical selected from the PFPE group, and irrespective of the selection of M1, M2 may be a chemical selected from the PFPE group. However, the embodiment of the present disclosure is not limited thereto. In M₁ and M₂, the subscript number of “a” and “b” may be each independently 1 to 200. For example, the subscript number of “a” may be a number selected from a range of 1 to 200, and irrespective of the selection of the “a,” the subscript number of “b” may be a number selected from a range of 1 to 200. The embodiment of the present disclosure, however, is not limited thereto.

In Formula F-1 and Formula F-2 above, A₁ and A₂ may be anchoring groups. For example, A₁ and A₂ may be each independently a functional group chemically bonded to the surface of the adhesive layer PM. In an embodiment, A₁ and A₂ may be each independently a substituted or unsubstituted amine group, a substituted or unsubstituted epoxy group, or a substituted or unsubstituted vinyl group. For example, A₁ may be selected from among a substituted amine group, an unsubstituted amine group, a substituted epoxy group, an unsubstituted epoxy group, a substituted vinyl group and an unsubstituted vinyl group. Irrespective of the selection of A₁, A₂ may be selected from among a substituted amine group, an unsubstituted amine group, a substituted epoxy group, an unsubstituted epoxy group, a substituted vinyl group and an unsubstituted vinyl group.

In an embodiment, in Formula F-1 and Formula F-2, L₁ and L₂ may be each independently a direct linkage, or a substituted or unsubstituted alkylene group having 1 to 50 carbon atoms. For example, L₁ may be selected from among a direct linkage, a substituted alkylene group having 1 to 50 carbon atoms, and an unsubstituted alkylene group having 1 to 50 carbon atoms. Irrespective of the selection of L₁, L₂ may be selected from among a direct linkage, a substituted alkylene group having 1 to 50 carbon atoms, and an unsubstituted alkylene group having 1 to 50 carbon atoms. In an embodiment, L₁ and L₂ may be each independently a substituted or unsubstituted alkylene group having 1 to 30 carbon atoms. However, the embodiment of the present disclosure is not limited thereto.

The adhesive layer PM may be disposed on the low refractive layer LRL. The adhesive layer PM may be disposed between the low refractive layer LRL and the functional layer AF to increase the bonding strength between the low refractive layer LRL and the functional layer AF. That is, the adhesive layer PM may be an auxiliary layer that increases the bonding strength between the low refractive layer LRL and the functional layer AF.

In an embodiment, the adhesive layer PM may include a silane coupling agent. The adhesive layer PM includes the silane coupling agent, and thus the adhesive strength between the low refractive layer LRL and the functional layer FL may be increased. The adhesive layer PM may include the silane coupling agent to increase the bonding strength with adjacent layers, thereby preventing damage to the window WM-1 even in wear vibration or chemical exposure. In addition, since the adhesive layer PM includes the silane coupling agent, the adhesion of the functional layer AF increases, and thus, the hydrophobicity of the functional layer AF may be maintained even in the wear vibration.

The silane coupling agent may include two alkoxysilanes and an amine group linked to the two alkoxysilanes. Each of the two alkoxysilanes may be linked to an amine group by a linking group. The linking group may be a substituted or unsubstituted alkylene group having 1 to 20 carbon atoms. Specifically, the silane coupling agent may include a first alkoxysilane and a second alkoxysilane, and the first alkoxysilane and the second alkoxysilane may be respectively linked to an amine group by a first linking group and a second linking group. Meanwhile, in the adhesive layer PM, such a silane coupling agent may be provided alone or a mixture of two or more thereof, but the embodiment of the present disclosure is not limited thereto.

In an embodiment, the silane coupling agent may be represented by Formula S below:

(ORₐ)₃Si—Lₐ—A—L_{b}—Si(OR_{b})₃ [Formula S]

In Formula S, Rₐ and R_{b} may be each independently a substituted or unsubstituted alkyl group having 1 to 20 carbon atoms. For example, Rₐ may be selected from among a substituted alkyl group having 1 to 20 carbon atoms and an unsubstituted alkyl group having 1 to 20 carbon atoms. Irrespective of the selection of Rₐ, R_{b} may be selected from among a substituted alkyl group having 1 to 20 carbon atoms and an unsubstituted alkyl group having 1 to 20 carbon atoms. In an embodiment, Rₐ and R_{b} may be each independently a substituted or unsubstituted alkyl group having 1 to 10 carbon atoms. In an embodiment, Rₐ and R_{b} may be each independently a substituted or unsubstituted methyl group, or a substituted or unsubstituted ethyl group. For example, Rₐ and R_{b} may be each independently an unsubstituted methyl group or an unsubstituted ethyl group.

In Formula S, Lₐ and L_{b} may be each independently a substituted or unsubstituted alkylene group having 1 to 20 carbon atoms. For example, Lₐ may be selected from among a substituted alkylene group having 1 to 20 carbon atoms and an unsubstituted alkylene group having 1 to 20 carbon atoms. Irrespective of the selection of Lₐ, L_{b} may be selected from among a substituted alkylene group having 1 to 20 carbon atoms and an unsubstituted alkylene group having 1 to 20 carbon atoms. In an embodiment, Lₐ and L_{b} may be each independently a substituted or unsubstituted alkylene group having 1 to 10 carbon atoms.

In Formula S, A may be a substituted or unsubstituted amine group. A may be NR_{c}. R_{c} may be a hydrogen atom, a deuterium atom, a substituted or unsubstituted alkyl group having 1 to 20 carbon atoms, a substituted or unsubstituted aryl group having 6 to 30 ring-forming carbon atoms, or a substituted or unsubstituted heteroaryl group having 2 to 30 ring-forming carbon atoms. For example, R_{c} may be a hydrogen atom.

In an embodiment, the silane coupling agent may be represented by Formula S-1 below:

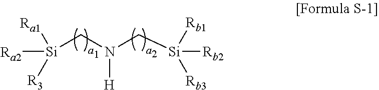

In Formula S-1, Rₐ₁ to Rₐ₃, and R_{b1} to R_{b3} may be each independently a substituted or unsubstituted alkoxy group. Hereinafter, the term “each independently” means that a chemical of the listed element can be selected from chemical groups irrespective of selection of a chemical of another listed element. In an embodiment, Rₐ₁ to Rₐ₃, and R_{b1} to R_{b3} may be each independently a substituted or unsubstituted methoxy group, or a substituted or unsubstituted ethoxy group. For example, Rₐ₁ to Rₐ₃, and R_{b1} to R_{b3} may be each independently an unsubstituted methoxy group, or an unsubstituted ethoxy group.

In Formula S-1, a₁ and a₂ are each independently an integer of 1 to 10. For example, a₁ and a₂ may be each independently 3, but the embodiment of the present disclosure is not limited thereto.

The number of silicon atoms (Si) contained in the silane coupling agent may be more than the number of nitrogen atoms (N) contained in the silane coupling agent. In an embodiment, the atomic ratio of nitrogen atoms and silicon atoms contained in the silane coupling agent may be about 1:1.8 to about 1:2.2. For example, the atomic ratio of nitrogen atoms and silicon atoms contained in the silane coupling agent may be about 1:2. When the atomic ratio of nitrogen atoms and silicon atoms contained in the silane coupling agent satisfies the above-described range, the adhesive layer PM may exhibit excellent durability. When the adhesive layer PM including the silane coupling agent in which the atomic ratio of nitrogen atoms and silicon atoms satisfies the above-described ranges is applied to the window WM, the window WM of an embodiment may exhibit excellent durability.

In an embodiment, the thickness of the adhesive layer PM may be about 5 nm to about 30 nm. For example, when the thickness of the adhesive layer PM satisfies the above-described range, low refractive layer LRL and the functional layer FL may be sufficiently bonded to each other without increasing the entire thickness of the window WM.

Referring to FIG. 6B, the window WM-2 of an embodiment may further include a hard coating layer HC disposed between the base layer BF and the high refractive layer HRL. The hard coating layer HC may function to protect the base layer BF of the window WM or the display module DM (see FIG. 3). The descriptions of the base layer BF, the high refractive layer HRL, and the low refractive layer LRL of the window WM-2 described with reference to FIG. 5A may be equally applied to a base layer BF, a high refractive layer HRL, and a low refractive layer LRL of an embodiment illustrated in FIG. 6B. In addition, the description of the functional layer AF and the adhesive layer PM described with reference to FIG. 6A may be equally applied to the functional layer AF and the adhesive layer PM of an embodiment illustrated in FIG. 6B.

The window WM-2 of an embodiment illustrated in FIG. 6B may include the base layer BF, the hard coating layer HC disposed on the base layer BF, the high refractive layer HRL disposed on the hard coating layer HC, and the low refractive layer LRL disposed on the high refractive layer HRL.

The hard coating layer HC may be directly disposed on the upper surface of the base layer BF. However, the disposition of the hard coating layer HC is not limited to that illustrated in FIG. 6B, and in the window WM-2 of an embodiment, the hard coating layer HC may be disposed on the lower portion of the base layer BF. Alternatively, the window WM-2 of an embodiment may further include an additional hard coating layer (not shown) disposed on the lower portion of the base layer BF in addition to the hard coating layer HC disposed on the upper portion of the base layer BF.

The hard coating layer HC may be formed from a hard coating layer resin containing at least one of an organic-based composition, an inorganic-based composition, and an organic-inorganic composite composition. For example, the hard coating agent forming the hard coating layer may include at least one of an acrylate-based compound, a siloxane compound, and a silsesquioxane compound. In addition, the hard coating agent may further include inorganic particles. The hard coating layer HC may be an organic layer, an inorganic layer, or an organic-inorganic composite material layer.

In the window WM of an embodiment, the thickness dc of the hard coating layer HC may be about 3 μm to about 10 μm. When the thickness dc of the hard coating layer HC is less than about 3 μm, the function of protecting the base layer BF may deteriorate, and thus the durability of the window WM-2 may deteriorate. In addition, when the thickness dc of the hard coating layer HC is less than about 3 μm, sufficient surface hardness for protecting the display module DM (see FIG. 3) may not be exhibited. In addition, when the thickness d_{C} of the hard coating layer HC is greater than about 10 μm, the thickness of the window WM-2 becomes thicker, and thus it may not be suitable for implementing a thin display device or a foldable display device. When the thickness dc of the hard coating layer HC is about 3 μm to about 10 μm, the hard coating layer HC may have excellent hardness, maintain flexibility, and exhibit improved mechanical properties.

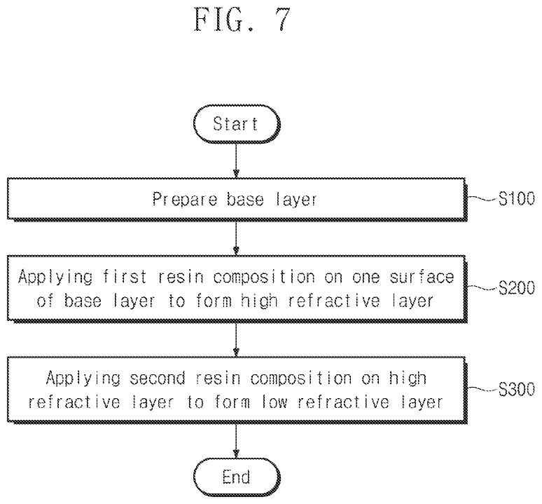

Hereinafter, a method of manufacturing a window of an embodiment will be described with reference to FIGS. 7 and 8A to 8E. The description of the window of an embodiment as described above may be applied to a window in the description of the method for manufacturing the window of an embodiment. Hereinafter, in the description of the method for manufacturing a window of an embodiment, contents duplicated with the description of the window according to the forgoing embodiment will not be described again, and differences therebetween will be mainly described.

The method for manufacturing a window of an embodiment may be a method for manufacturing the windows WM, WM-1, and WM-2 of an embodiment described with reference to FIGS. 5A, 6A, and 6B. An embodiment provides a method for manufacturing the windows WM, WM-1, and WM-2 disposed on the display panel DP of the display device DD.

FIG. 7 is a flowchart illustrating a method for manufacturing a window of an embodiment.

Referring to FIG. 7, the method for manufacturing a window of an embodiment may include preparing a base layer (S100), applying a first resin composition on one surface of the base layer to form a high refractive layer (S200), and applying a second resin composition on the high refractive layer to form a low refractive layer (S300).

FIGS. 8A to 8D are views schematically illustrating steps for manufacturing the window according to an embodiment of the present disclosure. FIG. 8E is an enlarged view of a cross-sectional view illustrating a part of the steps for manufacturing the window according to an embodiment of the present disclosure. FIG. 8A illustrates a step for providing a first resin composition RC1 for forming a high refractive layer HRL, FIG. 8B illustrates a step for irradiating a preliminary high refractive layer P-HRL with first light UV1, FIG. 8C illustrates a step for providing a second resin composition RC2 for forming the low refractive layer LRL, and FIG. 8D illustrates a step for irradiating a preliminary low refractive layer P-LRL with second light UV2. FIG. 8E is an enlarged view of a region “AA” of FIG. 8D.

FIGS. 8A and 8B schematically illustrate a step (S200) for providing the first resin composition RC1 on the base layer BF.

Referring to FIG. 8A, the first resin composition RC1 for forming the high refractive layer HRL may be provided on at least one surface of the base layer BF. The base layer BF may serve as a substrate for coating with the first liquid resin composition RC1.

The first resin composition RC1 may contain a highly stretchable material. The same as described in FIG. 5A may be applied to the first resin composition RC1.

The first resin composition may further contain a first base resin. The first base resin may include or may be formed of an acrylic-based resin, a urethane-based resin, a fluorine-based resin, an epoxy-based resin, a polyester-based resin, a polyamide-based resin, a silicone-based resin, or a combination thereof. In an embodiment, the first base resin may be provided in the form of a monomer or oligomer. The first base resin may be in the liquid form before being cured.

The first resin composition RC1 may further include at least one initiator. In an embodiment, the initiator contained in the first resin composition RC1 may be a photoinitiator which is activated from light in an ultraviolet region. The photoinitiator may be a photoinitiator which is activated by ultraviolet light having a center wavelength in a wavelength region of about 100 nm to about 400 nm. When the first resin composition RC1 includes a plurality of photoinitiators, different photoinitiators may be activated by ultraviolet light in different central wavelength regions. Meanwhile, in the present specification, the center wavelength refers to a wavelength representing a maximum intensity of an emission peak in an emission spectrum of a light source. However, the embodiment of the present disclosure is not limited thereto, and the first resin composition RC1 may include a thermal initiator.

The photoinitiator may be any one selected from among 2,2-dimethoxy-1,2-diphenylethan-1-one, 1-hydroxy-cyclohexyl-phenyl-ketone, 2-hydroxy-2-methyl-1-phenyl-1-propanone, 2-hydroxy-1-[4-(2-hydroxyethoxy)phenyl]-2-methyl-1-propanone, and 2-hydroxy-1-{4-[4-(2-hydroxy-2-methyl-propionyl)-benzyl]-phenyl}-2-methylpropan-1-one.

In addition, the photoinitiator may be any one selected from among 2-methyl-1-[4(methylthio)phenyl]-2-morpholinopropan-1-one, 2-benzyl-2-dimethylamino-1-(4-morpholinophenyl)-butanone-1, 2-dimethylamino-2-(4-methyl-benzyl)-1-(4-morpholin-4-yl-phenyl)-butan-1-one, 2,4,6-trimethylbenzoyl-diphenylphosphine oxide, 2,4,6-trimethylbenzoyl-diphenyl phosphinate, bis(2,4,6-trimethylbenzoyl)-phenylphosphineoxide, [1 -(4-phenylsulfanylbenzoyl)heptylideneamino]benzoate, [1-[9-ethyl-6-(2-methylbenzoyl)carbazol-3-yl]ethylideneamino] acetate, and bis(2,4-cyclopentadienyl)bis[2,6-difluoro-3-(1-pyrryl)phenyl] titanium(IV). However, the embodiment of the present disclosure is not limited thereto.

The first resin composition RC1 may further include inorganic particles. The first resin composition RC1 may further include at least one of a tin oxide (SnOₓ), a titanium oxide (TiOₓ), a zirconium oxide (ZrOₓ), and a sulfur atom.

The first resin composition RC1 may further include an additive as necessary. The same as described of the first resin composition in FIG. 5A may be applied to the additive contained in the first resin composition RC1.

The fifth resin composition RC1 may be provided in various methods. For example, the first resin composition RC1 may be provided in a method such as an inkjet printing method and a dispensing method. The first resin composition RC1 may be provided through a first supply nozzle NZ, such that a uniform coating thickness is maintained on the base layer BF.

The first resin composition RC1 of an embodiment is coated in a uniform thickness, and thus the first light UV1 may be provided to the provided preliminary high refractive layer P-HRL. In an embodiment, the first light UV1 may be ultraviolet light, but the embodiment of the present disclosure is not limited thereto. The first light UV1 for curing the first resin composition RC1 may be provided to the preliminary high refractive layer P-HRL. The preliminary high refractive layer P-HRL may be polymerized and then cured by the first light UV1 provided to form the high refractive layer HRL. The amount of the first light UV1 irradiated may be an amount of light enough to completely cure the first resin composition RC1. However, the embodiment of the present disclosure is not limited thereto.

Referring to FIG. 8C, the second resin composition RC2 for forming the low refractive layer LRL may be provided on the high refractive layer HRL.

The second resin composition RC2 may contain hollow particles HP and a first initiator including fluorine. The same as described in FIG. 5A may be applied to the first resin composition RC2.

The second resin composition RC2 may further contain a second base resin. The second base resin may include or may be formed of an acrylic-based resin, a urethane-based resin, a fluorine-based resin, an epoxy-based resin, a polyester-based resin, a polyamide-based resin, a silicone-based resin, or a combination thereof. The second base resin may be provided in the form of a monomer or oligomer. The second base resin may be in the liquid form before being cured.

The second resin composition RC2 may further contain a second initiator. The second initiator may be different from the first initiator. The second initiator may not contain fluorine. In an embodiment, the second initiator contained in the second resin composition RC2 may be a photoinitiator which is activated from light in an ultraviolet region. The second initiator may be a photoinitiator which is activated by ultraviolet light having a center wavelength in a wavelength region of about 100 nm to about 400 nm. However, the embodiment of the present disclosure is not limited thereto, and the second resin composition RC2 may include a thermal initiator.

The second resin composition RC2 may further include an additive as necessary. The same as described of the second resin composition in FIG. 5A may be applied to the additive contained in the second resin composition RC2.

The second resin composition RC2 may be provided in various methods. For example, the second resin composition RC2 may be provided in a method such as an inkjet printing method and a dispensing method. The second resin composition RC2 may be provided through a second supply nozzle NZ2, such that a uniform coating thickness is maintained.

The second resin composition RC2 of an embodiment is coated in a uniform thickness on the high refractive layer HRL, and thus the provided preliminary low refractive layer P-LRL may be irradiated with the second light UV2. In an embodiment, the second light UV2 may be ultraviolet light, but the embodiment of the present disclosure is not limited thereto. The second light UV2 may be the same as or different from the first light UV1 described in FIG. 8B. The second light UV2 for curing the second resin composition RC2 may be provided to the preliminary low refractive layer P-LRL. The preliminary low refractive layer P-LRL may be polymerized and then cured by the second light UV2 provided to form the low refractive layer LRL. The amount of the second light UV2 irradiated may be an amount of light enough to completely cure the second resin composition RC2. However, the embodiment of the present disclosure is not limited thereto.

Referring to FIG. 8E, the preliminary low refractive layer P-LRL before being cured may include hollow particles HP, a first initiator FPT, and a second base resin BS. The concentration of the first initiator FPT in the preliminary low refractive layer P-LRL may increase as a portion of the preliminary low refractive layer P-LRL is closer to the upper surface of the preliminary low refractive layer P-LRL. The first initiator FPT may be a material including fluorine and having low surface energy. The first initiator FPT may be a material having lower surface energy than the second base resin BS. Accordingly, in the preliminary low refractive layer P-LRL including the first initiator FPT, phase separation may occur due to a difference in surface energy between the first initiator FPT and the second base resin BS. The first initiator FPT may move to the upper portion of the preliminary low refractive layer P-LRL.

The hollow particles HP may be uniformly distributed in the preliminary low refractive layer P-LRL. The concentration of the first initiator FPT may increase from the lower surface toward the upper surface in the preliminary low refractive layer P-LRL. Therefore, when the preliminary low refractive layer P-LRL is formed by applying the second resin composition containing the hollow particles HP, the first initiator FPT, and the second base resin BS on the base layer BF, the hollow particles HP and the first initiator FPT may not be uniformly mixed due to low surface energy of the first initiator FPT.

In the curing of the preliminary low refractive layer P-LRL, the first initiator FPT may be cured and fixed to the upper portion in the state of phase-separation. Accordingly, the low refractive layer LRL including the second low refractive layer LRL-b including the hollow particles HP and most of the fluorine derived from the first initiator FPT after being cured, and the first low refractive layer LRL-a including no fluorine or only a very small amount of fluorine may be formed.

The window manufactured through the steps of FIGS. 8A to 8E may be applied to the above-described display device ED. The window manufactured through the steps of FIGS. 8A to 8E may be provided on the display panel DP. The windows manufactured through the steps of FIGS. 8A to 8E may be formed in a separate process and provided on the display panel DP. However, the embodiment of the present disclosure is not limited thereto, and the window WM may be formed on the display panel DP through a continuous process.

Hereinafter, the window of an embodiment and the display device including the window will be described in more detail through Examples and Comparative Examples. However, the following Examples and Comparative Examples are only examples for explaining the present disclosure in more detail, and the present disclosure is not limited by the following Examples and Comparative Examples.

### EXAMPLES

### 1. Manufacture and Evaluation of Window

### (Manufacture of Example 1)

A window including the stacked structure illustrated in FIG. 6A is manufactured. The window of Example includes a high refractive layer formed by using a first resin composition of an embodiment and a low refractive layer formed by using a second resin composition of an embodiment. That is, the window of Example includes a base layer sequentially stacked, a high refractive layer including a first polymer formed from a first resin composition containing a highly stretchable material, a low refractive layer including a second polymer formed from a second resin composition containing hollow particles and a first initiator, an adhesive layer, and a functional layer.

### (Manufacture of Comparative Example 1)

A window of Comparative Example is different from the window of Example in that the window of Comparative Example further includes a hard coating layer between the base layer and the high refractive layer, and includes a high refractive layer formed of a resin composition not including a highly stretchable material, and a low refractive layer formed of a resin composition not including a first initiator.

### 1. Evaluation of Window 1

Abrasion resistance and chemical resistance are evaluated for the evaluation of the windows according to Example and Comparative Example. Each evaluation method is as follows.

### (1) Abrasion Resistance

Abrasion resistance may be referred to as eraser abrasion resistance. The abrasion resistance is evaluated by observing, with the naked eye, the surface after an abrasion test is performed with an eraser, or measuring a water contact angle on the surface.

The window to be evaluated is cut into 7 cm×8 cm, fixed to a jig of a scratch tester (Daesung Precision Co., Ltd.), and Rubber stick (Minoan Co., Ltd.) having a diameter of 6 mm is mounted and fixed to the tip. The Rubber stick is subjected to reciprocating friction on the surface of an anti-fingerprint layer of the test window by setting the moving distance as 15 mm, the moving speed as 50 rpm, and the load as 1.0 kg, and then the surface of the Rubber stick is observed with the naked eye, or the water contact angle of the worn surface after the reciprocating friction is measured according to the method for measuring a water contact angle as described above.

### (2) Chemical Resistance

Chemical resistance may be referred to as eraser chemical resistance. The chemical resistance is evaluated by providing a chemical on the surface of the window and observing, with the naked eye, the surface after being worn out with an eraser, or measuring a water contact angle on the surface.

The window to be evaluated is cut into 7 cm×8 cm, fixed to a jig of a scratch tester (Daesung Precision Co., Ltd.), and Rubber stick (Minoan Co., Ltd.) having a diameter of 6 mm is mounted and fixed to the tip. After anhydrous ethanol is sprayed on the surface of the anti-fingerprint layer of the test window, and in the presence of the ethanol, the Rubber stick is subjected to reciprocating friction on the surface of the anti-fingerprint layer of the test window by setting the moving distance as 15 mm, the moving speed as 50 rpm, and the load as 1.0 kg, and then the surface of the Rubber stick is observed with the naked eye, or the surface after the reciprocation friction is cleaned several times, and the water contact angle of the worn surface is measured according to the method for measuring a water contact angle as described above.

TABLE 1

| | | Comparative | |
|---|---|---|---|
| Division | | Example 1 | Example 1 |
| Abrasion | Number of times | 2000 | 4000 |
| resistance | Water contact | <95° | ≥95° |
| | angle | | |
| Chemical | Number of times | 500 | 1000 |
| resistance | Water contact | <95° | ≥95° |
| | angle (°) | | |

Referring to Table 1 above, it may be confirmed that the window of Example 1 has excellent abrasion resistance and chemical resistance because the water contact angle is maintained at 95° or more even after abrasion resistance and chemical resistance evaluation as compared to Comparative Example 1. In addition, in the abrasion resistance and chemical resistance test, it is observed that the surface of Comparative Example 1 is damaged after 2,000 times and 500 times of reciprocating friction, and in Example 1, good surface properties are exhibited even after 4,000 times and 1,000 times of reciprocating friction. Example further contains the highly stretchable material in the first resin composition for forming high refractive layer, and further contains the first initiator in the second resin composition for forming low refractive layer, thereby exhibiting excellent chemical resistance as compared with Comparative Example. That is, it may be seen that the window of Example exhibits excellent mechanical properties and durability compared to Comparative Example. In addition, the window of Example 1 may exhibit excellent durability even if the window does not include the hard coating layer compared to Comparative Example 1. The window of Example includes the high refractive layer formed from the first resin composition containing the highly stretchable material, thereby exhibiting high refractive properties while having a hard coating function. Accordingly, when the window of Example is applied to the display device, excellent durability is exhibited and at the same time the overall thickness of the display device may be reduced.

### 1. Reflectance Measurement

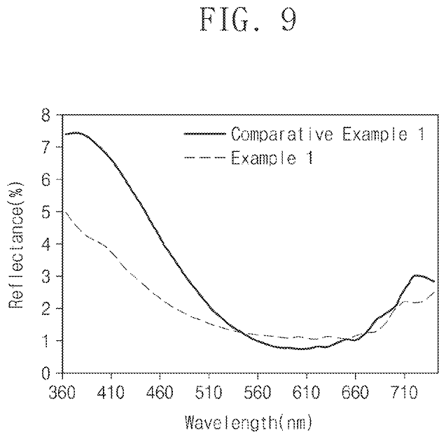

FIG. 9 shows evaluation results of optical properties of the windows of Example 1 and Comparative Example 1. In FIG. 9, reflectance is measured with equipment of CM-3700A (KONICA MINOLTA, Inc.). When the reflectance is measured, a D65 light source is used, and the reflectance is measured under a 2° viewing angle condition.

Referring to FIG. 9, the reflectance of Example 1 in the wavelength range of about 360 nm to about 710 nm is a low reflectance of about 6% or less. In addition, in the wavelength region of about 360 nm to about 510 nm, which is a short wavelength region, the window of Example 1 exhibited lower reflectance properties compared to Comparative Example 1. Accordingly, it may be confirmed that the window according to Example exhibits low-reflection properties superior to that of Comparative Example. Therefore, when the window of Example is applied to the display device, it may be possible to achieve excellent optical properties.

Referring to the results of Table 1 and FIG. 9, the window of Example may satisfy physical properties of abrasion resistance and chemical resistance and at the same time exhibit excellent optical properties having a reflectance of about 6% or less. That is, the window of Example may exhibit excellent durability such as abrasion resistance and chemical resistance, and excellent optical properties of low reflectance at the same time.

### 2. Evaluation of Window 2

Tables 2 to 4 show the evaluation results of the windows of Examples. Chemical resistance in Tables 2 to 4 is evaluated by observing, with the naked eye, the surface condition after friction. In Tables 2 to 4, crack strain indicates an increment in the size of the stretched sample with respect to the initial test sample when the test sample is stretched. The test sample at the time of crack strain measurement is prepared by laser cutting the sample into a size of 1.0 cm×10 cm. The tensile speed is 10 mm/min, and after the sample is stretched, the occurrence of cracks is confirmed with a microscope, and an increment in the sample size at this time is confirmed and evaluated.

Physical properties according to the amount of the first initiator contained in the second resin composition are evaluated, and the results are shown in Table 2 below.

Examples 1-1 to 1-3 have the window structure in FIG. 6A as described above. Examples 1-1 to 1-3 differ from each other in the amount of the first initiator contained in the second resin composition. That is, Examples 1-1 to 1-3 are evaluated by varying the amount of the first initiator contained in the second resin composition. In Example 1-1, the second resin composition containing about 3 wt % of the first initiator with respect to the total weight of the second resin composition is used. In Example 1-2, the second resin composition containing about 5 wt % of the first initiator with respect to the total weight of the second resin composition is used. In Example 1-3, the second resin composition containing about 8 wt % of the first initiator with respect to the total weight of the second resin composition is used. Meanwhile, the materials used in Example 1 are equally applied to the materials for forming the base layer, the high refractive layer, the low refractive layer, the adhesive layer, and the functional layer.

TABLE 2

| Division | Example 1-1 | Example 1-2 | Example 1-3 |
|---|---|---|---|
| Crack strain (%) | 7 | 8 | 9 |
| Chemical resistance | 3000 | 3000 | 2000 |
| (times) | | | |

Referring to Table 2, in Examples 1-1 to 1-3, the crack strain value is measured to be about 7% or more, and it is observed that the surface is damaged after at least 2,000 times of reciprocating friction even in the chemical resistance test. Meanwhile, when Examples 1-1 to 1-3 are compared, it may be confirmed that the crack strain value increases as the amount of the first initiator increases, but the value decreases in the chemical resistance test. It may be confirmed that Examples 1-1 and 1-2 using the second resin composition containing about 5 wt % or less of the first initiator exhibit higher crack strain values and also exhibit good chemical resistance properties as compared with Example 1-3 using the second resin composition containing greater than about 5 wt % of the first initiator. That is, it may be confirmed that the first initiator is contained in an amount of about 5 wt % or less in the second resin composition, and thus excellent durability may be exhibited.

Table 3 below show the evaluation results of the windows of Examples. Physical properties according to the amount of the highly stretchable material contained in the first resin composition are evaluated, and the results are shown in Table 3 below.

Examples 2-1 to 2-3 have the window structure in FIG. 6A as described above. Examples 2-1 to 2-3 differ from each other in the amount of the highly stretchable material contained in the first resin composition. That is, Examples 2-1 to 2-3 are evaluated by varying the amount of the highly stretchable material contained in the first resin composition. In Examples 2-1 to 2-3, the compound represented by Formula A-1 is used as the highly stretchable material. In Example 2-1, the first resin composition containing about 3 wt % of the highly stretchable material with respect to the total weight of the first resin composition is used. In Example 2-2, the first resin composition containing about 5 wt % of the highly stretchable material with respect to the total weight of the first resin composition is used. In Example 2-3, the first resin composition containing about 8 wt % of the highly stretchable material with respect to the total weight of the first resin composition is used. Meanwhile, the materials used in Example 1 are equally applied to the materials for forming the base layer, the high refractive layer, the low refractive layer, the adhesive layer, and the functional layer.

TABLE 3

| Division | Example 2-1 | Example 2-2 | Example 2-3 |
|---|---|---|---|
| Crack strain (%) | 6 | 8 | 9 |
| Chemical resistance | 3000 | 3000 | 2000 |
| (times) | | | |

Referring to Table 3 above, in Examples 2-1 to 2-3, the crack strain value is measured to be about 6% or more, and it is observed that the surface is damaged after at least 2,000 times of reciprocating friction even in the chemical resistance test. Meanwhile, when Examples 2-1 to 2-3 are compared, it may be confirmed that the crack strain value increases as the amount of the highly stretchable material represented by Formula A-1 increases, but the value decreases in the chemical resistance test. It may be confirmed that Examples 2-1 and 2-2 using the first resin composition containing about 5 wt % or less of the highly stretchable material exhibit higher crack strain values and also exhibit good chemical resistance properties as compared with Example 2-3 using the first resin composition containing greater than about 5 wt % of the highly stretchable material. That is, it may be confirmed that the highly stretchable material represented by Formula A-1 is contained in an amount of about 5 wt % or less in the first resin composition, and thus excellent durability may be exhibited.

Table 4 below show the evaluation results of the windows of Examples. Physical properties according to the amount of the highly stretchable material contained in the first resin composition are evaluated, and the results are shown in Table 4 below.

Examples 3-1 to 3-3 have the window structure in FIG. 6A as described above. Examples 3-1 to 3-3 differ from each other in the amount of the highly stretchable material contained in the first resin composition. That is, Examples 3-1 to 3-3 are evaluated by varying the amount of the highly stretchable material contained in the first resin composition. In Examples 3-1 to 3-3, the compound represented by Formula A-2 is used as the highly stretchable material. In Example 3-1, the first resin composition containing about 10 wt % of the highly stretchable material with respect to the total weight of the first resin composition is used. In Example 3-2, the first resin composition containing about 20 wt % of the highly stretchable material with respect to the total weight of the first resin composition is used. In Example 3-3, the first resin composition containing about 30 wt % of the highly stretchable material with respect to the total weight of the first resin composition is used. Meanwhile, the materials used in Example 1 are equally applied to the materials for forming the base layer, the high refractive layer, the low refractive layer, the adhesive layer, and the functional layer.

TABLE 4

| Division | Example 3-1 | Example 3-2 | Example 3-3 |
|---|---|---|---|
| Crack strain (%) | 5 | 7 | 9 |
| Chemical resistance | 4000 | 3000 | 2000 |
| (times) | | | |

Referring to Table 3 above, in Examples 3-1 to 3-3, the crack strain value is measured to be about 5% or more, and it is observed that the surface is damaged after at least 2,000 times of reciprocating friction even in the chemical resistance test. Meanwhile, when Examples 3-1 to 3-3 are compared, it may be confirmed that the crack strain value increases as the amount of the highly stretchable material represented by Formula A-2 increases, but the value decreases in the chemical resistance test. It may be confirmed that Example 3-1 using the first resin composition containing about 10 wt % or less of the highly stretchable material exhibit higher crack strain values and also exhibit good chemical resistance properties as compared with Example 3-3 using the first resin composition containing greater than about 10 wt % of the highly stretchable material. That is, it may be confirmed that the highly stretchable material represented by Formula A-2 is contained in an amount of about 10 wt % or less in the first resin composition, and thus excellent durability may be exhibited.

According to an embodiment of the present disclosure, the window includes the high refractive layer derived from the resin composition including the highly stretchable material and the low refractive layer derived from the resin composition including the hollow particles and fluorine, and thus may exhibit excellent abrasion resistance and chemical resistance, and excellent optical properties having reduced reflection rate. Accordingly, the durability and optical properties of the display device including the window may be improved.

Although the present disclosure has been described with reference to an embodiment of the present disclosure, it will be understood that the present disclosure should not be limited to these embodiments but various changes and modifications can be made by those skilled in the art without departing from the spirit and scope of the present disclosure. Accordingly, the technical scope of the present disclosure is not intended to be limited to the contents set forth in the detailed description of the specification, but is intended to be defined by the appended claims.

What is claimed is:

1. A window comprising:
a base layer;
a high refractive layer which is disposed on the base layer and includes a first polymer derived from a first resin composition containing a highly stretchable material; and
a low refractive layer which is disposed on the high refractive layer and includes a second polymer derived from a second resin composition containing hollow particles and a first initiator including fluorine,
wherein the highly stretchable material is represented by Formula A-1 or Formula A-2 below, and
the second resin composition contains about 5 wt % or less of the first initiator with respect to the total amount of the second resin composition: 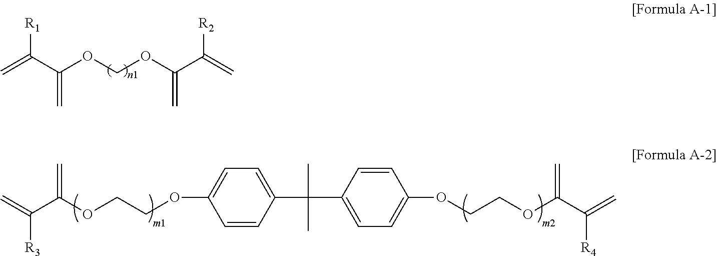
wherein, in Formulae A-1 and A-2 above,
R₁ to R₄ are each independently a hydrogen atom, or a substituted or unsubstituted methyl group,
n1 is an integer selected from a range of 6 to 10,
each of m1 and m2 is an integer independently selected from a range of 1 to 20, and the sum of m1 and m2 is 30 or less.

2. The window of claim 1,
wherein the highly stretchable material is represented by Formula A-1 above, and
the first resin composition contains about 5 wt % or less of the highly stretchable material with respect to the total amount of the first resin composition.

3. The window of claim 1,
wherein the highly stretchable material is represented by Formula A-2 above, and
the first resin composition contains about 5 wt % to about 10 wt % of the highly stretchable material with respect to the total amount of the first resin composition.

4. The window of claim 1,
wherein the high refractive layer has a thickness selected from a range of about 3,000 nm to about 5,000 nm, and
the low refractive layer has a thickness selected from a range of about 50 nm to about 90 nm.

5. The window of claim 1,
wherein the high refractive layer has a refractive index selected from a range of about 1.52 to about 1.67, and
the low refractive layer has a refractive index selected from a range of about 1.42 to about 1.50.

6. The window of claim 1,
wherein the high refractive layer further comprises at least one of a tin oxide (SnOₓ), a titanium oxide (TiOₓ), a zirconium oxide (ZrOₓ), and a sulfur atom.

7. The window of claim 1,
wherein the low refractive layer comprises:
a first low refractive layer which is disposed on the high refractive layer and includes the hollow particles, and
a second low refractive layer including the fluorine.

8. The window of claim 1,
wherein the second resin composition further contains a second initiator different from the first initiator.

9. The window of claim 1,
wherein the hollow particles have an average diameter selected from a range of about 50 nm to about 90 nm.

10. The window of claim 1,
wherein an amount of the hollow particles contained in the second resin composition is selected from a range of about 25 wt % to about 35 wt % with respect to the total amount of the second resin composition.

11. The window of claim 1, further comprising:
a functional layer which is disposed on the low refractive layer and includes a fluorine-containing compound.

12. The window of claim 11, further comprising:
an adhesive layer which is disposed between the functional layer and the low refractive layer and includes a silane coupling agent,
wherein the silane coupling agent has an atomic ratio of nitrogen atoms and silicon atoms that is selected from a range of about 1:1.8 to about 1:2.2.

13. A display device comprising:
a display panel; and
a window disposed on the display panel,
wherein the window comprises:
a base layer;
a high refractive layer which is disposed on the base layer and includes a first polymer derived from a first resin composition containing a highly stretchable material; and
a low refractive layer which is disposed on the high refractive layer and includes a second polymer derived from a second resin composition containing hollow particles and a first initiator including fluorine,
wherein the highly stretchable material is represented by Formula A-1 or Formula A-2 below, and
the second resin composition contains about 5 wt % or less of the first initiator with respect to the total amount of the second resin composition: 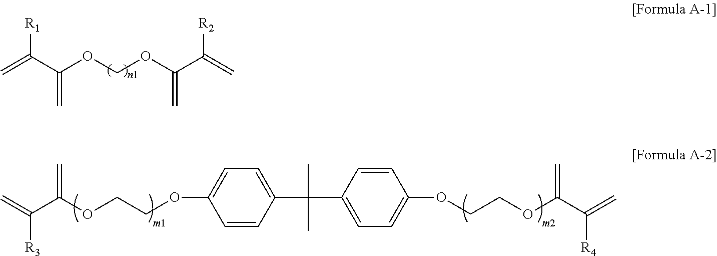
wherein, in Formulae A-1 and A-2 above,
R₁ to R₄ are each independently a hydrogen atom, or a substituted or unsubstituted methyl group,
n1 is an integer selected from a range of 6 to 10,
each of m1 and m2 is an integer independently selected from a range of 1 to 20, and
the sum of m1 and m2 is 30 or less.

14. The display device of claim 13,
wherein the highly stretchable material is represented by Formula A-1 above, and
the first resin composition contains about 5 wt % or less of the highly stretchable material with respect to the total amount of the first resin composition.

15. The display device of claim 13,
wherein the highly stretchable material is represented by Formula A-2 above, and
the first resin composition contains about 5 wt % to about 10 wt % of the highly stretchable material with respect to the total amount of the first resin composition.

16. The display device of claim 13,
wherein the high refractive layer has a thickness selected from a range of about 3,000 nm to about 5,000 nm, and
the low refractive layer has a thickness selected from a range of about 50 nm to about 90 nm.

17. The display device of claim 13,
wherein the low refractive layer comprises:
a first low refractive layer which is disposed on the high refractive layer and includes the hollow particles, and
a second low refractive layer including the fluorine.

18. The display device of claim 13,
wherein an amount of the hollow particles contained in the second resin composition is selected from a range of about 25 wt % to about 35 wt % with respect to the total amount of the second resin composition.

19. The display device of claim 13,
wherein the display device comprises at least one folding region which is folded with respect to a folding axis extending in one direction.

20. A method for manufacturing a window, the method comprising:
preparing a base layer;
applying, on one surface of the base layer, a first resin composition containing a highly stretchable material to form a high refractive layer; and
applying, on the high refractive layer, a second resin composition containing hollow particles and a first initiator including fluorine to form a low refractive layer,
wherein the highly stretchable material is represented by Formula A-1 or Formula A-2 below, and
the second resin composition contains about 5 wt % or less of the first initiator with respect to the total amount of the second resin composition: 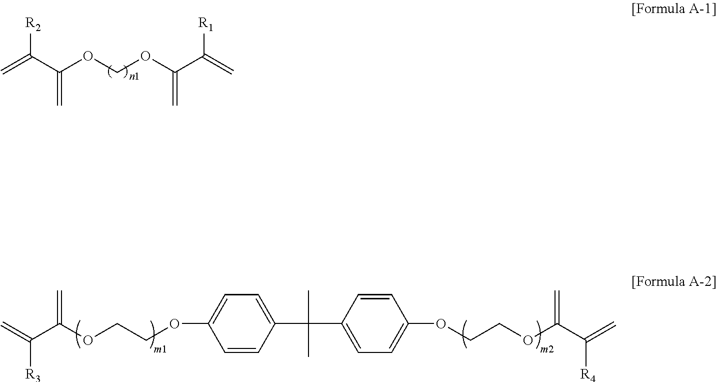
wherein, in Formulae A-1 and A-2 above,
R₁ to R₄ are each independently a hydrogen atom, or a substituted or unsubstituted methyl group,
n1 is an integer selected from a range of 6 to 10,
each of m1 and m2 is an integer independently selected from a range of 1 to 20, and
the sum of m1 and m2 is 30 or less.
